(19) United States
(12) Patent Application Publication
(10) Pub. No.: US 2016/0173662 A1
(43) Pub. Date: Jun. 16, 2016

(54) METHOD AND DEVICE FOR TRANSMITTING AND RECEIVING SHORT FRAME FRAGMENT IN WIRELESS LAN SYSTEM

(71) Applicant: LG ELECTRONICS INC., Seoul (KR)

(72) Inventor: Yongho SEOK, Seoul (KR)

(73) Assignee: LG ELECTRONICS INC., Seoul (KR)

(21) Appl. No.: 14/906,826

(22) PCT Filed: Jul. 28, 2014
(86) PCT No.: PCT/KR2014/006869

§ 371 Date: Jan. 21, 2016

Related U.S. Application Data
(60) Provisional application No. 61/868,053, filed on Aug. 20, 2013.
(60) Provisional application No. 61/936,814, filed on Feb. 6, 2014.

(51) Int. Cl. H04L 29/08; H04L 1/16; H04W 84/12

(52) U.S. Cl. CPC H04L 69/324; H04W 84/12; H04L 1/1628

(57) ABSTRACT

The present invention relates to a wireless communication system and, more particularly, to a method and device for transmitting and receiving a short frame fragment in a wireless LAN system. A method of transmitting a fragment frame by means of a station (STA) in a wireless LAN system according to an embodiment of the present invention includes the steps of transmitting a plurality of fragment frames generated from a frame; and receiving a response frame for one or more of the fragment frames, wherein a response indication field of fragment frames excluding the last fragment frame from among the plurality of fragment frames may be set as a value representing the maximum length.

### TECHNICAL FIELD

The present invention relates to a wireless communication system, and more particularly, to a method of transmitting and receiving a short fragment frame in a wireless LAN system and an apparatus therefor.

### BACKGROUND ART

With recent development of information communication technologies, a variety of wireless communication technologies have been developed. From among such technologies, WLAN is a technology that allows wireless Internet access at home, in businesses, or in specific service providing areas using a mobile terminal, such as a personal digital assistant (PDA), a laptop computer, and a portable multimedia player (PMP), based on radio frequency technology,

In order to overcome limited communication speed, which has been pointed out as a weak point of WLAN, technical standards have recently introduced a system capable of increasing the speed and reliability of a network while extending a coverage region of a wireless network. For example, IEEE 802.11n supports high throughput (HT) with a maximum data processing speed of 540 Mbps. In addition, Multiple Input Multiple Output (MIMO) technology, which employs multiple antennas for both a transmitter and a receiver in order to minimize transmission errors and optimize data rate, has been introduced.

### DISCLOSURE OF THE INVENTION

### Technical Task

Machine-to-machine (M2M) communication technology has been discussed as a next generation communication technology. Technical standard IEEE 802.11ab to support M2M communication in the IEEE 802.11 WLAN system is also under development. The M2M communication can consider a scenario of communicating a small amount of data sometimes with low speed in environment that a huge number of devices exist.

An object of the present invention is to provide a method of performing retransmission based on a block ACK and a method of performing transmission using a short data frame format in case of transmitting and receiving a short frame fragment to save power of an STA and avoid an incorrect operation.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a method of transmitting a fragment frame, which is transmitted by a station (STA) in a wireless LAN system, includes transmitting a plurality of fragment frames generated from a single frame and receiving a response frame in response to one or more fragment frames among the plurality of the fragment frames, in this case, a response indication field of a fragment frame other than a last fragment frame among the plurality of the fragment frames, can be configured by a value indicating a maximum length.

To further achieve these and other advantages and in accordance with the purpose of the present invention, according to a different embodiment, a method of receiving a fragment frame, which is received by a station (STA) in a wireless LAN system, includes receiving a plurality of fragment frames generated from a single frame and transmitting a response frame in response to one or more fragment: frames among the plurality of the fragment frames. In this case, a response indication field of a fragment frame other than a last fragment frame among the plurality of the fragment frames, can be configured by a value indicating a maximum length.

To further achieve these and other advantages and in accordance with the purpose of the present invention, according to a further different embodiment, a station (STA) transmitting a fragment frame in a wireless LAN system can include a transceiver and a processor, the processor configured to control the transceiver to transmit a plurality of fragment frames generated from a single frame and receive a response frame in response to one or more fragment frames among the plurality of the fragment frames. In this ease, a response indication field of a fragment frame other than a last fragment frame among the plurality of the fragment frames, can be configured by a value indicating a maximum length.

To further achieve these and other advantages and in accordance with the purpose of the present invention, according to a further different embodiment, a station (STA) receiving a fragment frame in a wireless LAN system includes a transceiver and a processor configured to control the transceiver to receive a plurality of fragment frames generated from a single frame and transmit a response frame in response to one or more fragment frames among the plurality of the fragment frames. In this case, a response indication field of a fragment frame other than a last fragment frame among the plurality of the fragment frames, can be configured by a value indicating a maximum length.

In embodiments according to the present invention, following items can be applied.

The response indication field of the fragment frame other than the last fragment frame, can be configured by a value indicating a long response.

A response indication field of the last fragment frame can be configured by a value indicating an null data packet (NDP) response or a normal response.

If a response frame is received in response to each of the plurality of the fragment frames, a duration field of the response frame for the fragment frame other than the last fragment frame, can be configured by a value indicating a maximum length.

If a response frame is received in response to each of the plurality of the fragment frames, a duration field of the last fragment frame can be set to 0.

When a response frame for the plurality of the fragment frames is received as a block ACK frame, if a value of an ACK policy field of the fragment frame other than the last fragment frame, is configured by a value indicating a block ACK, the response indication field of the fragment frame other than the last fragment frame, can be configured by a value indicating the maximum length.

When a response frame for the plurality of the fragment frames is received as a block ACK frame. If a value of an ACK policy field of a single fragment frame among the plurality of the fragment frames is configured by a value indicating an implicit block ACK request, a response indication field of the single fragment frame can he configured by a value indicating an null data packet (NDP) block ACK response or a block ACK response,

When a response frame for the plurality of the fragment frames is received as a block ACK frame, if a value of an ACK policy field of a single fragment frame among the plurality of the fragment frames is configured by a value indicating an implicit block ACK request, a value of a duration field of the block ACK frame can be set to 0.

A value of a More fragment field, of an FC (frame control) field of the fragment frame other than the last fragment frame, is set to 1 and a value of a More fragment field of an frame control (FC) field of the last fragment frame can be set to 0.

Each of the plurality of the fragment frames can be transmitted using a short data frame format.

A More Fragment bit can be masked to 0 in additional authentication data (ADD) for each of the plurality of the fragment frames.

A More Fragment bit can be masked to 0 in Nonce for each of the plurality of the fragment frames.

It is to be understood that both the foregoing general description and the following detailed description are exemplary and explanatory and are intended to provide further explanation of the invention as claimed.

### Advantageous Effects

According to the present invention, it is able to provide a method of performing retransmission based on a block ACK and a method of performing transmission using a short data frame format in case of transmitting and receiving a short frame fragment.

Effects obtainable from the present invention ma be non-limited by the above mentioned effect. And, other unmentioned effects can be clearly understood from the following description by those having ordinary skill in the technical field to which the present invention pertains.

### DESCRIPTION OF DRAWINGS

The accompanying drawings, which are included to provide a further understanding of the present invention, illustrate various embodiments of the present invention and together with the descriptions in this specification serve to explain the principle of the invention.

FIG. 1 is a diagram showing an exemplary structure of an IEEE 802.11 system to which the present invention is applicable;

FIG. 2 is a diagram showing another exemplary structure of an IEEE 802.11 system to which the present invention is applicable;

FIG. 3 is a diagram showing still another exemplary structure of an IEEE 802.11 system to which the present invention is applicable;

FIG. 4 is a diagram showing an exemplary structure of a WLAN system;

FIG. 5 illustrates a link setup process in a WLAN system;

FIG. 6 illustrates a backoff process;

FIG. 7 illustrates a hidden node and an exposed node;

FIG. 8 illustrates RTS and CTS;

FIG. 9 illustrates a power management operation;

FIGS. 10 to 12 illustrate operations of a station (STA) having received a TIM in detail;

FIG. 13 is a diagram for explaining a group-based AID;

FIG. 14 is a diagram for explaining an example of a frame structure used in IEEE 801.11 system;

FIG. 15 is a diagram for explaining an example of a long-range PLCP frame format;

FIG. 16 is a transmission flow for explaining a repetition scheme to configure a PCP frame format for 1 MHz bandwidth;

FIG. 17 is a block diagram for explaining CCMP encapsulation

FIG. 18 is a diagram for an exemplary configuration of a frame control field of a short MAC header according to the present invention;

FIG. 19 is a diagram for an exemplary configuration of AAD according to the present invention;

FIG. 20 is a diagram for an exemplary configuration of Nonce according to the present invention;

FIG. 21 is a diagram for a method of transmitting a fragment according to one example of the present invention;

FIG. 22 is a diagram for an example of a short data frame format;

FIG. 23 is a diagram for an exemplary format of a FC field of a short data frame format;

FIG. 24 is a diagram for an exemplary format of an NDP ACK frame;

FIG. 25 is a diagram for explaining a method according to one example of the present invention;

FIG. 26 is a block diagram for a configuration of a wireless device according to one embodiment of the present invention.

### BEST MODE

### Mode for Invention

Reference will now be made in detail to exemplary embodiments of the present invention, examples of which are illustrated in the accompanying drawings. The detailed description, which will be given below with reference to the accompanying drawings, is intended to explain exemplary embodiments of the present invention, rather than to present all embodiments that can be implemented according to the invention. The following detailed description includes specific details in order to provide a thorough understanding of the present invention. However, it will be apparent to those skilled in the art that the present invention may be practiced without such specific details.

The embodiments described below are constructed by combining elements and features of the present invention in a predetermined form. The elements or features may be considered selective unless explicitly mentioned otherwise. Each of the elements or features can be implemented without being combined with other elements. In addition, some elements and/or features may be combined to configure an embodiment of the present invention. The sequence of the operations discussed in the embodiments of the present invention may be changed. Some elements or features of one embodiment may also be included in another embodiment, or may be replaced by corresponding elements or features of another embodiment.

Specific terms are employed in the following description for better understanding of the present invention. Such specific terms may take other forms within the technical scope or spirit of the present invention.

In some cases, well-known structures and devices are omitted in order to avoid obscuring the concepts of the present invention and important functions of the structures and devices may be mainly illustrated in the form of block diagrams.

Exemplary embodiments of the present invention are supported by standard documents disclosed for at least one of an Institute of Electrical and Electronics Engineers (IEEE) 802 system, a 3rd Generation Partnership Project (3GPP) system, a 3GPP Long Term Evolution (LTE) system, an LTE-Advanced (LTE-A) system, and a 3GPP2 system, which are wireless access systems. That is, steps or parts which are not described to clearly reveal the technical spirit of the present invention in the embodiments of the present invention may be supported by the above documents. All terminology used herein may be supported by at least one of the aforementioned documents.

The following embodiments of the present invention can be applied to a variety of wireless access technologies such as, for example, CDMA (Code Division Multiple Access), FDMA (Frequency Division Multiple Access), TDMA (Time Division Multiple Access), OFDMA (Orthogonal Frequency Division Multiple Access), and SC-FDMA (Single Carrier Frequency Division Multiple Access). CDMA may be embodied through a radio technology such as UTRA (Universal Terrestrial Radio Access) or CDMA2000. TDMA may be embodied through radio technologies such as GSM (Global System for Mobile communication)/GPRS (General Packet Radio Service)/EDGE (Enhanced Data Rates for GSM Evolution). OFDMA may be embodied through radio technologies such as IEEE 802.11 (Wi-Fi), IEEE 802.16 (WiMAX), IEEE 802.20, and E-UTRA (Evolved UTRA). For clarity, the following description mainly focuses on IEEE 802.11 systems, but technical features of the present invention are not limited thereto.

Structure of WLAN System

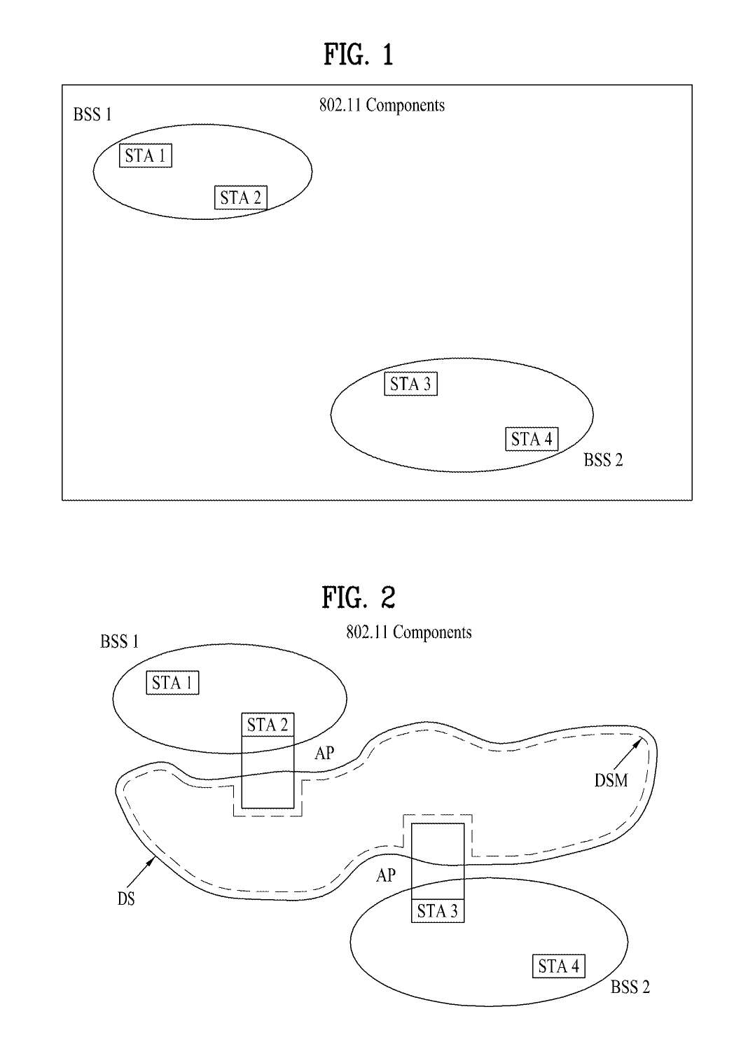

FIG. 1 is a diagram showing an exemplary structure of an IEEE 802.11 system to which the present invention is applicable.

The structure of the IEEE 802.11 system may include a plurality of components. A WLAN which supports transparent STA mobility for a higher layer may he provided by interaction between components. A Basic Service Set (BSS) may correspond to a basic component block in an IEEE 802.11 LAN. In FIG. 1, two BSSs (BSS1 and BSS2) are shown and each of the BSSs includes two STAs as members thereof (i.e., STA1 and STA2 are included in BSS1, and STA3 and STA4 are included in BSS2). In FIG. 1, an ellipse indicating each BSS may be understood as a coverage area in which STAs included in the BSS maintain communication. This area may be referred to as a basic service area (BSA). If an STA moves out of the BSA, the STA cannot directly communicate with the other STAs within the BSA.

In the IEEE 802.11 LAN, the most basic type of BSS is an independent BSS (IBSS). For example, the IBSS may have a minimal form consisting of only two STAs. The BSS (BSS1 or BSS2) of FIG. 1, which is the simplest form and in which other components are omitted, may correspond to a typical example of the IBSS. Such configuration is possible when STAs can directly communicate with each other. This type of LAN may be configured when the LAN is necessary, rather than being prescheduled. This network may be referred to as an ad-hoc network.

Memberships of an STA in a BSS may be dynamically changed depending on whether the STA is switched on or of and whether the STA enters or leaves the BSS area. The STA may use a synchronization process to join the BSS to be a member of the BSS. To access all services of a BSS infrastructure, the STA should be associated with the BSS. Such association may be dynamically established and may involve use of a distribution system service (DSS).

FIG. 2 is a diagram showing another exemplary structure of an IEEE 802.11 system to which the present invention is applicable. In FIG. 2, components such as a distribution system (DS), a distribution system medium (DSM), and an access point (AP) are added to the structure of FIG. 1.

A direct STA-to-STA distance in a LAN may be limited by physical layer (PHY) performance. In some cases, such limited distance may be sufficient for communication. However, in other cases, communication between STAs over a long distance may be necessary. The DS may be configured to support extended coverage.

The DS refers to a structure in Which BSSs are connected to each other. Specifically, a BSS may be configured as a component of an extended form of a network including a plurality of BSSs, rather than being independently present as shown in FIG. 1.

The DS is a logical concept and may be specified by the characteristics of the DSM. In this regard, a wireless medium (WM) and the DSM are logically distinguished from each other in IEEE 802.11. Respective logical media are used for different purposes and are used by different components. According to IEEE 802.11, such media are not restricted to either the same or different media. The flexibility of the IEEE 802.11 LAN architecture (DS architecture or other network architectures) can be explained by the fact that plural media are logically different from each other. That is the IEEE 802.11 LAN architecture can be implemented in various manners and may be independently specified by a physical property of each implementation.

The DS may support mobile devices by providing seamless integration of multiple BSSs and providing logical services necessary for handling an address to a destination.

The AP refers to an entity that enables associated STAs to access the DS through a WM and that has STA functionality. Data may move between the BSS and the DS through the AP. For example, STA2 and STA3 shown in FIG. 2 have STA functionality and provide a function of causing associated STAs (STA1 and STA4) to access the DS. Moreover, since all APs basically correspond to STAs, all APs are addressable entities. An address used by an AP for communication on the WM need not be identical to an address used by the AP for communication on the DSM.

Data transmitted from one of STAs associated with the AP to an STA address of the AP may always be received by an uncontrolled port and may be processed by an IEEE 802.1X port access entity. If the controlled port is authenticated, transmission data (or frames) may be transmitted to the DS.

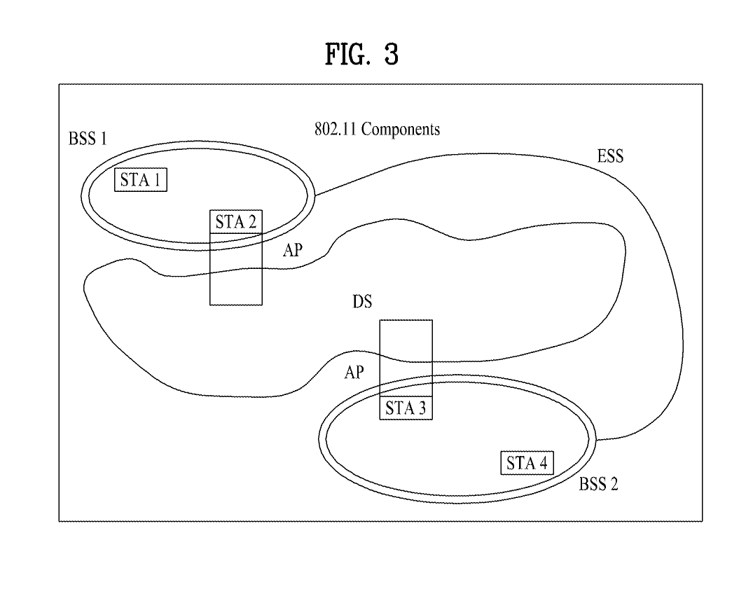

FIG. 3 is a diagram showing still another exemplary structure of an IEEE 802.11 system to which the present invention is applicable, in addition to the structure of FIG. 2, FIG. 3 conceptually shows an extended service set (ESS) for providing wide coverage.

A wireless network having arbitrary size and complexity may be constructed by a DS and BSSs. In the IEEE 802.11 system, this type of network is referred to as an ESS network. The ESS may correspond to a set of BSSs connected to one DS. However, the ESS does not include the DS. The ESS network is characterized in that the ESS network is viewed as an IBSS network in a logical link control (LLC) layer, STAs included in the ESS may communicate with each other and mobile STAs are movable transparently from one BSS to another BSS (within the same ESS) in LLC.

Regarding relative physical locations of the BSSs in FIG. 3, IEEE 802.11 does not assume any arrangement, and all the following arrangements are possible. BSSs may partially overlap and this positional arrangement is generally used to provide continuous coverage. In addition, the BSSs may not be physically connected, and a distance between BSSs is not logically limited. The BSSs may be located at the same physical position and this positional arrangement may be adopted to provide redundancy. One (or at least one IBSS or ESS network may be physically present in one space as one (or at least one) ESS network. This may correspond to an ESS network form taken in the case in which an ad-hoc network operates in a location where the ESS network is present, in the case in which IEEE 802.11 networks of different organizations physically overlap, or in the case in which two or more different access and security policies are needed in the same location.

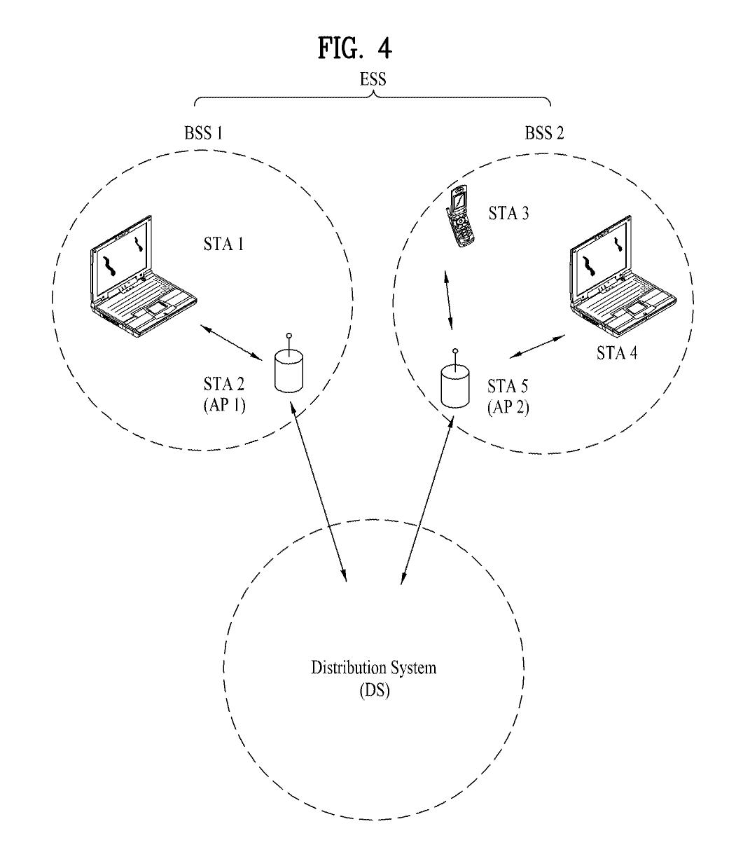

FIG. 4 is a diagram showing an exemplary structure of a WLAN system, FIG. 4 shows an exemplary infrastructure BSS including a DS.

In the example of FIG. 4, BSS1 and BSS2 constitute an ESS. In the WLAN system, an STA is a device operating according to MAC(Medium Access Control)/PHY(Physical) regulation of IEEE 802.11. STAs include AP STAs and non-AP STAs. The non-AP STAs correspond to devices such as laptop computers or mobile phones which are generally handled directly by users. In the example of FIG. 4, STA 1, STA 3, and STA 4 correspond to the non-AP STAs and STA 2 and STA 5 correspond to AP STAs.

In the following description, the non-AP STA may be called a terminal, a wireless transmit/receive unit (WTRU), user equipment (UE), a mobile station (MS), a mobile terminal, or a mobile subscriber station (MSS). The AP is a concept corresponding to a base station (BS), a Node-B, an evolved Node-B (e-NB), a base transceiver system (BTS), or a femto BS in other wireless communication fields.

Layer Structure

Operation of an STA in a wireless LAN system can be described in terms of a layer structure. A layer structure in a device configuration can be implemented by a processor. STA may have a multiple layer structure. For example, 802.11 standard document mainly describes a MAC sublayer and a physical (PHY) layer on a data link layer (DLL). The PHY layer may include a PLCP (Physical Layer Convergence Procedure) entity, a PMD (Physical Medium Dependent) entity and the like. The MAC sublayer and PHY layer respectively include management entities, which are respectively called an MUM (MAC sublayer Management Entity) and a PLME (Physical Layer Management Entity). These entities provide a layer management service interface through which a layer management function is operated.

To provide accurate MAC operation, an SME (Station Management Entity) is present in each STA. The SME is a layer-independent entity which is present in a separate management plane or can be regarded as off to the side. While functions of the SME are not described in detail in the specification, the SME can be considered to execute functions of collecting layer-dependent statues from various layer management entities (LMEs), setting layer-specific parameters to similar values and the like. The SME can execute such functions on behalf of normal system management entities and implement a standard management protocol, in general.

The aforementioned entities interact in various manners. For example, entities can interact by exchanging GET/SET primitives there between. A primitive refers to a set of elements of parameters related to a specific purpose. XX-GET.request primitive is used to request the value of a given MIB attribute (management information based attribute information). XX-GET.confirm primitive is used to return an appropriate MIB attribute information value in the case of a status of “success” and to return an error indication in a status field otherwise. XX-SET.request primitive is used to request an indicated MIB attributed to be set to a given value. When the MIB attribute refers to a specific operation, this represents request for execution of the operation. XX-SET.confirm primitive is used to confirm that an indicated MW attribute has been set to a requested value in the case of a status of “success” and to return an error condition in the status field otherwise. When the MIB attribute refers to a specific operation, this confirms that the corresponding operation has been performed.

In addition, the MLME and the SME can exchange various MLME_GET/SET primitives through an MLME_SAP (Service Access Point) therebetween. Furthermore, various PLME_GET/SET primitives can be exchanged between the PLME and the SME through a PLME_SAP and between the MLME and the PLME through an MLME-PLME_SAP.

Link Setup Process

FIG. 5 illustrates a general link setup process.

To set up a link with respect to the network and transmit/receive data over the network, the STA should perform network discovery and authentication, establish association, and perform an authentication procedure for security. The link setup process may also be referred to as a session initiation process or a session setup process. In addition, the discovery, authentication, association, and security setup steps in the link setup process may be collectively called an association step in a general sense.

Hereinafter, an exemplary link setup process will be described with reference to FIG. 5.

In step S510, an STA may perform the network discovery operation. The network discovery operation may include a scanning operation of the STA. That is, the STA needs to search for an available network so as to access the network. The STA needs to identify a compatible network before participating in a wireless network. Herein, the process of identifying a network contained in a specific region is referred to as scanning.

The scanning operation is classified into active scanning and passive scanning.

FIG. 5 exemplarily shows the network discovery operation including the active scanning process. In the case of active scanning, an STA configured to perform scanning transmits a probe request frame and waits for a response to the probe request frame, in order to move between channels and search for nearby APs. A responder transmits a probe response frame to the STA having transmitted the probe request frame, in response to the probe request frame. Herein, the responder may be the last STA that has transmitted a beacon frame in a BSS of the scanned channel. In the BSS, the AP transmits a beacon frame, and thus the AP serves as the responder. In the IBSS. STAs within the IBSS transmit a beacon frame in rotation, and thus the responder is not fixed. For example, the STA that has transmitted the probe request frame on Channel #1 and has received the probe response frame on Channel #1 may store BSS-related information that is contained in the received probe response frame and move to the next channel (for example, Channel #2) to perform scanning (i.e., transmission reception of a probe request/response on Channel #2) in the same manner.

Although not shown in FIG. 5, scanning: may be carried out in the passive scanning manner. In performing the passive scanning operation, an STA to perform scanning waits for a beacon frame while moving from one channel to another. The beacon frame, which is one of the management frames in IEEE 802.11, is periodically transmitted to inform of presence of a wireless network and to allow the STA performing scanning to find a wireless network and participate in the wireless network. In a BSS, the AP periodically transmits the beacon frame. In an IBSS STAs of the IBSS transmit the beacon frame in rotation. When an STA performing scanning receives a beacon frame, the STA stores information about the BSS contained in the beacon frame and moves to the next channel. In this manner, the STA records beacon frame information received on each channel. The STA having received a beacon frame stores BSS-related information contained in the received beacon frame and then moves to the next channel and performs scanning in the same manner.

In comparison between active scanning and passive scanning, active scanning is more advantageous than passive scanning in terms of delay and power consumption.

After the STA discovers the network, the STA may perform authentication in step S520. This authentication process may be referred to as first authentication, which is clearly distinguished from the security setup operation of step S540, which will be described later.

The authentication process may include transmitting, by the STA, an authentication request frame to an AP and transmitting, by the AP, an authentication response frame to the STA in response to the authentication request frame. The authentication frame used in transmitting an authentication request/response may correspond to a management frame.

The authentication frame may contain information about an authentication algorithm number, an authentication transaction sequence number, a status code, as challenge text, a robust security network (RSN), a finite cyclic group, etc. This information, which is an example of information that may be contained in the authentication request/response frame, may be replaced with other information, or include additional information.

The STA may transmit an authentication request frame to the AP. The AP may determine whether to authenticate the STA on the basis of the information contained in the received authentication request frame. The AP may provide an authentication result to the STA through the authentication response frame.

After the STA is successfully authenticated, the association process may be conducted in step S530. The association process may include transmitting, by the STA, an association request frame to the AP and transmitting, by the AP, an association response frame to the STA in response.

For example, the association request frame may include information related to various capabilities, a beacon listening interval, a service set identifier (SSID), supported rates, supported channels. RSN, mobility domain, supported operating classes, a traffic indication map (TIM) broadcast request, an interworking service capability, etc.

For example, the association response frame may include information related, to various capabilities, a status code, an association ID (AID), supported rates, an enhanced distributed channel access (EDCA) parameter set, a received channel power indicator (RCPI), a received signal to noise indicator (RSNI), mobility domain, a timeout interval (association comeback time), an overlapping BSS scan parameter, a TIM broadcast response, a QoS map, etc.

The aforementioned information, which corresponds to some parts of information which can be contained in the association request/response frame, may be replaced with other information or include additional information.

After the STA is successfully associated with the network, the security setup process may be performed in step S540. The security setup process of step S540 may be referred to as an authentication process based on a robust security network association (RSNA) request/response. The authentication process of step S520 may be referred to as a first authentication process, and the security setup process of step S540 may be simply referred to as an authentication process.

The security setup process of step S540 may include, for example, a process of performing private key setup based on 4-way handshaking through an extensible authentication protocol over LAN (EAPOL) frame. In addition, the security setup process may be performed using another security scheme that is not defined in IEEE 802.11 standards.

Evolution of WLAN

In order to overcome a limit in WLAN communication speed, IEEE 802.11n has recently been established as a communication standard. IEEE 802.11n aims to increase network speed and reliability as well as to extend wireless network coverage. More specifically, IEEE 802.11n supports a high throughput (FIT) of a maximum data processing speed of 540 Mbps, and is based on multiple input multiple output (MIMO) technology in which multiple antennas are used at both a transmitter and a receiver.

With widespread use of WLAN technology and diversification of WLAN applications, there has been a need for development of a new WLAN system capable of supporting higher throughput than a data processing speed supported by IEEE 802.11n. The next generation WLAN system for supporting very high throughput (WIT) is the next version (for example, IEEE 802.11ac) of the IEEE 802.11n WLAN system, and is one of IEEE 802.11 WLAN systems recently proposed to support a data processing speed greater than or equal to 1 Gbps at a MAC service access point (MAC SAP). To this end, VHT systems provide a channel bandwidth of 80 MHz or 160 MHz and up to 8 spatial streams. When a channel bandwidth of 160 MHz, 8 spatial streams, 256 QAM (Quadrature Amplitude Modulation) and a short guard interval (short GI) are all implemented, a transmission rate of up to 6.9 Gbps is provided.

In order to efficiently utilize a radio frequency channel, the next generation WLAN system supports a Multi User Multiple Input Multiple Output (MU-MIMO) transmission scheme in which a plurality of STAs can simultaneously access as channel. In accordance with the MU-MIMO transmission scheme, the AP may simultaneously transmit packets to at least one MIMO-paired STA.

In addition, a technology for supporting WLAN system operations in whitespace is under discussion. For example, a technology for introducing the WLAN system in TV whitespace (TV WS) such as a frequency baud (e.g., as band between 54 MHz and 698 MHz) left idle due to transition from analog TV ID digital TV has been discussed under the IEEE 802.11af standard. However, this is simply illustrative, and the whitespace may be viewed as a licensed band which is primarily usable by a licensed user. The licensed user means a user who has permission to use the licensed band, and may also be referred to as a licensed device, a primary user, an incumbent user, or the like.

For example, an AP and/or STA operating in the whitespace (WS) should provide a function of protecting the licensed user. For example, in the case in which a licensed user such as a microphone is already using a specific WS channel which is in a frequency band divided according to a regulation to have a specific bandwidth in the WS band, the AP and/or STA are not allowed to use the frequency band corresponding to the WS channel in order to protect the licensed user. In addition, the AP and/or STA should stop using a frequency band for transmission and/or reception of a current frame when the licensed user uses this frequency band.

Accordingly, the AP and/or STA need to pre-check whether use of a specific frequency band within the WS band is possible, namely whether a licensed user is in the frequency band. Checking whether a licensed, user is in the specific frequency band is referred to as spectrum sensing. An energy detection scheme, as signature detection scheme and the like are utilized as the spectrum sensing mechanisms. The AP and/or STA may determine that a licensed user is using the specific frequency band if the intensity of a received signal exceeds a predetermined value, or when a DTV preamble is detected.

Machine-to-machine (M2M) communication technology has been discussed as a next generation communication technology. Technical standard IEEE 802.11ah to support M2M communication in the IEEE 802.11 WLAN system is also under development. M2M communication, which represents a communication scheme involving one or more machines, may also be referred to as machine type communication (MTC) or machine-to-machine (M2M) communication. Herein, the machine may represent an entity that does not require direct manipulation from or intervention of a user. For example, not only a meter or vending machine equipped with a wireless communication module, but also user equipment such as a smartphone which is capable of performing communication by automatically accessing the network without manipulation/intervention by the user may be an example of the machines. M2M communication may include device-to-device (D2D) communication and communication between a device and an application server. As examples of communication between a device and an application server, there may be communication between a vending machine and an application server, communication between a Point of Sale (POS) device and an application server, and communication between an electric meter, a gas meter or a water meter and an application server. M2M communication-based applications may include security, transportation and healthcare applications. Considering the characteristics of the aforementioned application examples, M2M communication needs to support occasional transmission/reception of a small amount of data at a low speed in an environment including a large number of devices.

Specifically, M2M communication needs to support a large number of STAs. While the current WLAN system assumes that one AP is associated with up to 2007 STAs, various methods to support other cases in which many more STAs (e.g., about 6000 STAs) are associated with one AP have been discussed regarding M2M communication. In addition, it is expected that there will be many applications to support/require a low transfer rate in M2M communication. In order to smoothly support many STAs, an STA in the WLAN system may recognize presence or absence of data to be transmitted thereto on the basis of a traffic indication map (TIM), and several methods to reduce the bitmap size of the TIM have been under discussion. In addition, it is expected that there will be much traffic data having a very long transmission/reception interval in M2M communication. For example, in M2M communication, a very small amount of data such as electric/gas/water metering is required to be transmitted and received at long intervals (for example, every month). Accordingly, methods have been discussed to efficiently support the case in which a very small number of STAs have a data frame to receive from the AP during one beacon period while the number of STAs to be associated with one AP increases in the WLAN system.

As described above, WLAN technology is rapidly evolving, and not only the aforementioned exemplary techniques but also other techniques for direct link setup, improvement of media streaming throughput, support of high-speed and/or large-scale initial session setup, and support of an extended bandwidth and operation frequency are under development.

Medium Access Mechanism

In the IEEE 802.11-based WLAN system, a basic access mechanism of medium access control (MAC) is a Carrier Sense Multiple Access with Collision Avoidance (CSMA/CA) mechanism. The CSMA/CA mechanism, which is also called a Distributed Coordination Function (DCF) of IEEE 802.11 MAC, basically employs a “listen before talk” access mechanism. In accordance with this access mechanism, the AP and/or STA may perform Clear Channel Assessment (CCA) of sensing a radio frequency channel or medium in a predetermined time interval (e.g., DCF Inter-Frame Space (DIFS)), prior to data transmission. When it is determined in the sensing that the medium is in the idle state, frame transmission begins through the medium. On the other hand, when it is sensed that the medium is in the occupied state, the AP and/or STA does not start transmission, but establishes a delay time (e.g., a random backoff period) for medium access, and attempts to perform frame transmission after waiting during the period. Through application of a random backoff period, it is expected that multiple STAs will attempt to start frame transmission after waiting for different times, resulting in minimized collision.

In addition the IEEE 802.11 MAC protocol provides a hybrid coordination function (HCF), HCF is based on the DCF and the point coordination function (PCF). PCF refers to a polling-based synchronous access scheme in which polling is periodically executed to allow all reception APs and/or STAs to receive a data frame. In addition, the HCF includes enhanced distributed channel access (MCA) and HCF controlled channel access (HCCA). EDCA is achieved when the access scheme provided to multiple users by a provider is based on contention, HCCA is achieved in the contention-free channel access scheme which employs the polling mechanism. In addition, the HCF includes a medium access mechanism for improving Quality of Service (QoS) of the WLAN, and may transmit QoS data during both the contention period (CP) and the contention free period (CFP).

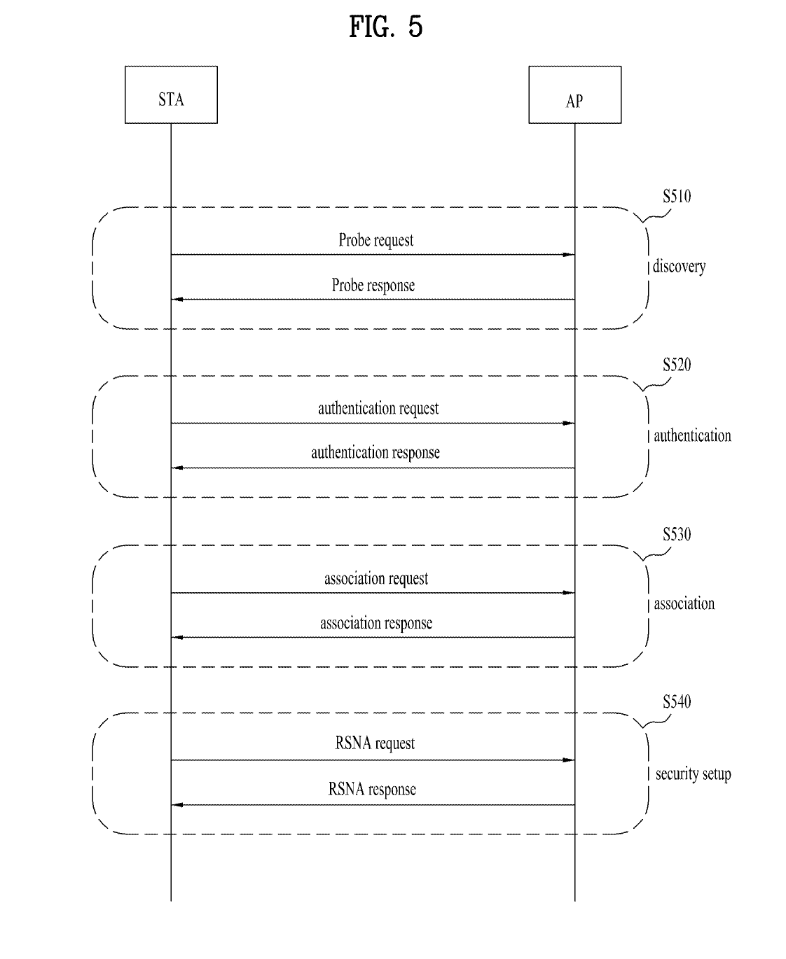

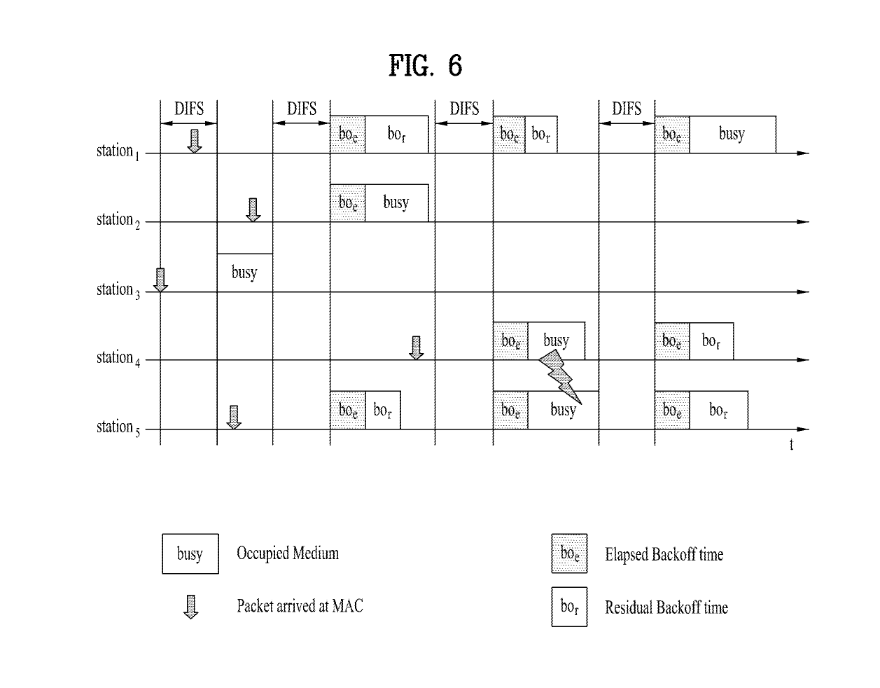

FIG. 6 illustrates a backoff process.

Hereinafter, operations based on a random backoff period will be described with reference to FIG. 6. If the medium is switched from the occupied or busy state to the idle state, several STAs may attempt to transmit data (or frames), in a method to minimize collisions, each STA selects a random backoff count, waits for a slot time corresponding to the selected backoff count, and then attempts to start transmission. The random backoff count has a value of a pseudo-random integer, and may be set to a value in a range between 0 and CW. Herein, CW is a contention window parameter value. Although the CW parameter is given CWmin as the initial value, the initial value may be doubled if transmission fails (for example, if ACK of the transmission frame is not received). If the CW parameter value is CWmax, CWmax is maintained until data transmission is successful, and at the same time data transmission may be attempted. If data transmission is successful, the CW parameter value is reset to CWmin. Preferably, the values of CW, CWmin and CWmax are set to 2n−1 (where n-0, 1, 2, . . . ).

Once the random backoff process begins, the STA continuously monitors the medium while counting down the backoff slot according to a determined backoff count value. If the medium is monitored as being in the occupied state, the STA stops the countdown and waits for a predetermined time. If the medium is in the idle state, the remaining countdown resumes.

In the example shown in FIG. 6, if a packet for STA3 to transmit reaches MAC of STA3, the STA3 may confirm that the medium is in the idle state in the DIES and immediately transmit a frame. In the meantime, the other STAs monitor the busy state of the medium, and operate in the standby mode. During operation of STA3, each of STA 1. STA2, and STA5 may have data to be transmitted. If the idle state of the medium is monitored, each of STA1, STA2, and STA5 waits for the DIFS time and then performs countdown of the backoff slot according to a random backoff count value which they have selected. In the example shown in FIG. 6, STA2 selects the lowest backoff count value and STA1 selects the highest backoff count value. That is, when the STA2 starts data transmission after completing backoff counting, the residual backoff time of STA5 is shorter than the residual backoff time of STA1. Each of STA1 and STA5 temporarily stops countdown and waits while STA2 occupies the medium. When occupancy by the STA2 is terminated and the medium returns to the idle state, each of STA1 and STA5 waits for a predetermined DIFS time, and restarts backoff counting. That is, after the residual backoff slot as long as the residual backoff time is counted down, frame transmission may start. Since the residual backoff time of STA5 is shorter than that of STA1, STA5 starts frame transmission. Meanwhile, STA4 may be given data to be transmitted while STA2 occupies the medium. In this case, when the medium is in the idle state, STA4 may wait for the DIFS time, perform countdown according to the random backoff count value selected by the STA4, and then start frame transmission. FIG. 6 exemplarily illustrates a case in which the residual backoff time of STA5 is equal to the random backoff count value of STA4 by chance. In this case, collision may occur between STA4 and STA5. If collision occurs between STA4 and STA5, neither STA4 nor STA5 receives ACK, and accordingly data transmission fails. In this case, each of STA4 and STA5 may double the CW value, select as random backoff count value and then perform countdown. Meanwhile, STA1 waits while the medium is in the occupied state due to transmission operation by STA4 and STA5, In this case, when the medium returns to the idle state. STA1 waits for the DIFS time and then starts frame transmission after lapse of the residual backoff time

Sensing Operation of STA

As described above, the CSMA/CA mechanism includes not only physical carrier sensing through which the AP and or STA directly sense the medium, but also virtual carrier sensing. The virtual carrier sensing is performed to address some problems such as a hidden node problem) encountered in medium access. In the virtual carrier sensing, MAC of the WLAN system may use a network allocation vector (NAV). By means of the NAV value, the AP and or STA which is using the medium or has authority to use the medium indicates, for another AP and or another STA, the remaining time before a time at which the medium becomes available. Accordingly, the NAV value may correspond to a reserved period during which the medium is used by the AP and/or STA to transmit a frame. An STA having received the NAV value may be prohibited from accessing the medium during the corresponding period. For example, NAV may be set according to the value of the duration field in the MAC header of a frame.

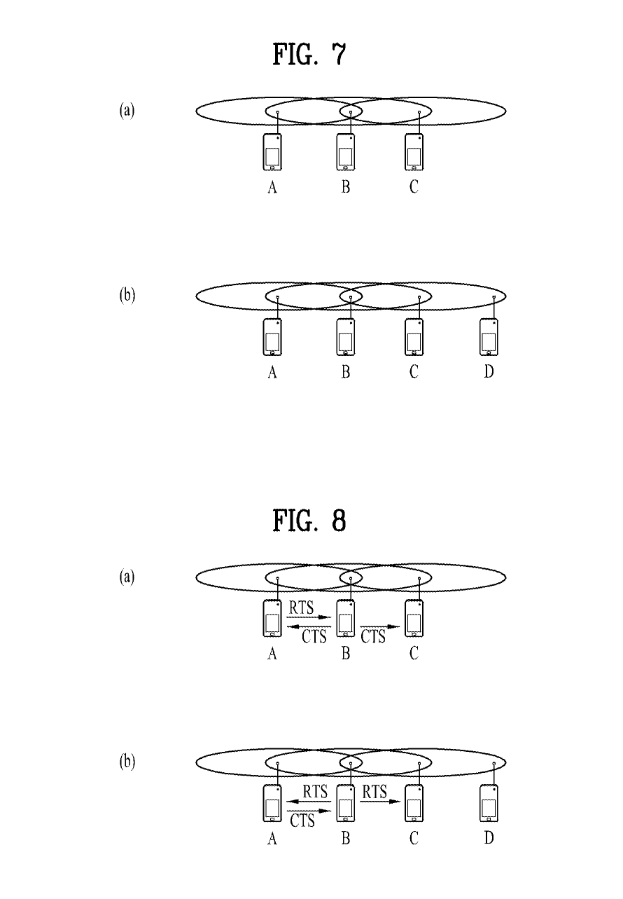

A robust collision detection mechanism has been introduced to reduce the probability of such collision. Hereinafter, this mechanism will be described with reference to FIGS. 7 and 8. The actual carrier sensing range may not be identical to the transmission range, but for simplicity of description, it will be assumed that the actual carrier sensing range is identical to the transmission range.

FIG. 7 illustrates a hidden node and an exposed node.

FIG. 7(a) exemplarily shows a hidden node. In FIG. 7(a), STA A communicates with STA B, and STA C has information to be transmitted. Specifically, when STA C performs carrier sensing prior to transmission of data to STA B, STA C may determine that the medium is in the idle state even in a situation in which STA A is transmitting information to STA B. This is because transmission by STA A (i.e., occupied medium) may not be sensed at the location of STA C. In this case, collision may occur since STA B receives information of STA A and information of STA C simultaneously. In this case, STA A may be considered as hidden node of STA C.

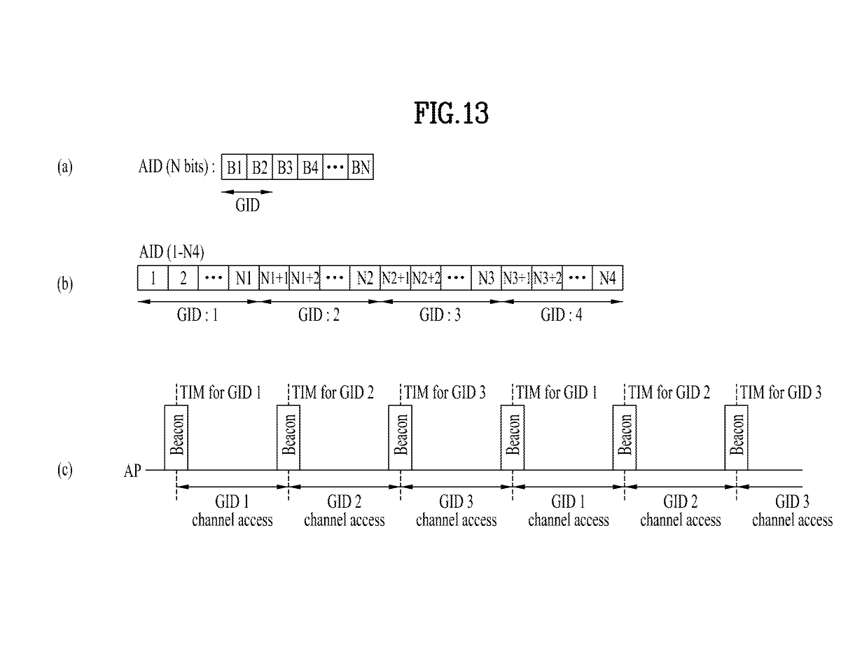

FIG. 7(b) exemplarily shows an exposed node. In FIG. 13(b), STA C has information to be transmitted to STA D in a situation in which STA B is transmitting data to STA A. In this case, STA C ma perform carrier sensing and determine that the medium is occupied due to transmission of STA B. Therefore, although STA C has information to be transmitted to STA D, STA C should wait until the medium switches back to the idle state since the occupied state of the medium is sensed. However, since STA A is actually located out of the transmission range of STA C, transmission from STA C may not collide with transmission from STA B in view of STA A, and STA C unnecessarily waits until STA B stops transmission. In this case, STA C may be viewed as an exposed node of STA B.

FIG. 8 illustrates RTS and CTS.

In order to efficiently use the collision avoidance mechanism in an exemplary situation as shown in FIG. 7, short-signaling packets such as RTS (request to send) and CTS (clear to send) may be used. RTS/CTS between two STAs may be overheard, by nearby STA(s), such that the nearby STA(s) may consider whether information is communicated between the two STAs. For example, if an STA to transmit data transmits an RTS frame to another STA that is to receive data, the STA to receive data may transmit a CTS frame to nearby STAs, thereby informing the nearby STAs that the STA is about to receive data.

FIG. 8(a) exemplarily shows as method to solve the hidden node problem. The method assumes a situation in which both STA A and STA C attempt to transmit data to STA B. If STA A transmits RTS to STA B, STA B transmits CTS to both STA A and STA C located around STA B. As a result, STA C waits until STA A and STA B stop data transmission, and thus collision is avoided.

FIG. 8(b) exemplarily shows a method to solve the exposed node problem. STA C may overhear RTS/CTS transmission between STA A and STA B, thereby determining that no collision will occur when it transmits data to another STA (e.g., STA D). That is, STA B may transmit RTS to all the nearby STAs, and transmits CTS only to STA A which actually has data to transmit. Since STA C receives only the RTS, but fails to receive the CTS of STA A, STA C may recognize that STA A is located out of the carrier sensing range of STA C.

Power Management

As described above, STAs in the WLAN system should perform channel sensing before they perform transmission/reception operation. Persistently performing channel sensing causes persistent power consumption of the STA. There is not much difference in power consumption between the reception state and the transmission state, and continuous maintenance of the reception state may cause large load to STAs which are provided with limited power (i.e., operated by a battery). Therefore, if an STA maintains the reception standby mode so as to persistently sense the channel, power is inefficiently consumed without special advantages in terms of WLAN throughput. To address this problem, the WLAN system supports a power management (PM) mode of the STA.

The PM mode of the STA is classified into an active mode and a power save (PS) mode. The STA is basically operated in the active mode. The STA operating in the active mode maintains an awake state. When the STA is in the awake state, the STA may normally perform frame transmission/reception, channel scanning, or the like. On the other hand, the STA in the PS mode operates by switching between the sleep state (or doze state) and the awake state. The STA in the sleep state operates with minimum power and performs neither frame transmission/reception nor channel scanning.

As the time for which the STA operates in the sleep state increases, power consumption of the STA is reduced, and accordingly the STA operation duration increases. However, since transmission or reception of the frame is not allowed in the sleep state, the STA cannot unconditionally operate in the sleep state for a long time. When the STA operating in the sleep state has a frame to transmit to the AP, it may be switched to the awake state to transmit/receive the frame. On the other hand, when the AP has a frame to transmit to the STA which is in the sleep state, the STA cannot receive the frame nor recognize the presence of the frame. Accordingly, in order to recognize presence or absence of a frame to be transmitted to the STA (or in order to receive the frame if the frame is present), the STA may need to switch to the awake state according to specific periodicity.

FIG. 9 illustrates a power management operation.

Referring to FIG. 9, AP 210 transmits a beacon frame to STAs present in the BSS at predetermined time intervals (S211, S212, S213, S214, S215 and S216). The beacon frame includes a traffic indication map (TIM) information element. The TIM information element contains information indicating that the AP 210 has buffered traffic for the STAs associated with the AP 210 and that a frame will be transmitted. The TIM element includes a TIM used to inform of a unicast frame and a delivery traffic indication map (DTIM) used to inform of a multicast or broadcast frame.

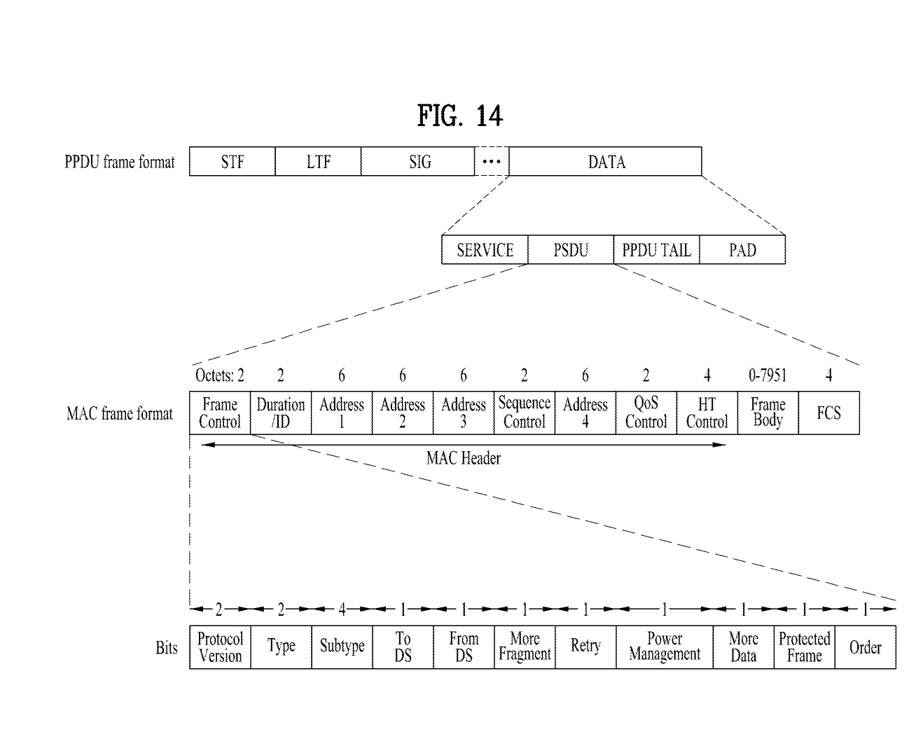

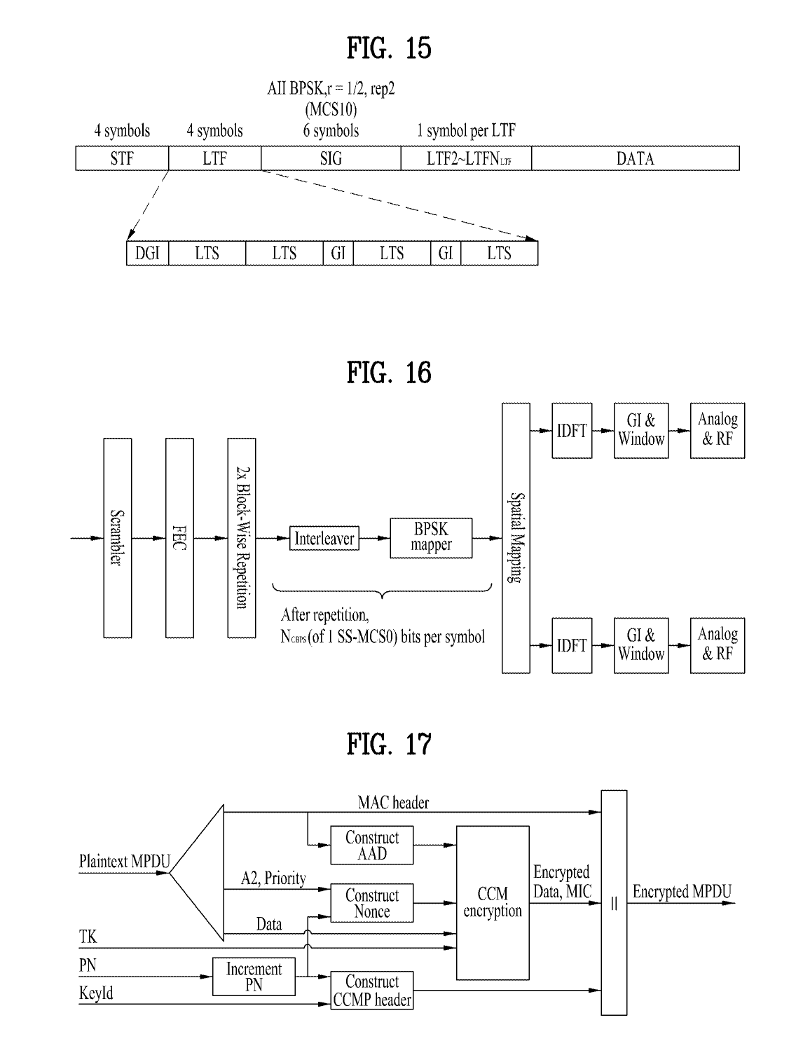

AP 210 may transmit a DTIM once per three transmissions of the beacon frame. STA1 220 and STA2 222 are STAs operating in the PS mode. Each of STA1 220 and STA2 222 may be switched from the sleep state to the awake state at every wakeup interval of a predetermined period to receive the TIM element transmitted by the AP 210. Each STA may calculate a switching time to switch to the awake state, based on its own local clock. In the example shown in FIG. 15, it is assumed that the clock of the STA coincides with that of the AP.

For example, the predetermined wakeup interval may be set in such a manner that STA1 220 can switch to the awake state at every beacon interval to receive the TIM element. Accordingly, when AP 210 transmits the beacon frame for the first time (S211). STA1 220 may switch to the awake state (S220. Thereby, STA1 220 may receive the beacon frame and acquire the TIM element. If the acquired TIM element indicates that there is a frame to be transmitted to STA1 220, STA1 220 may transmit a power save (PS)-Poll frame, which requests transmission of the frame, to the AP 210 (S221a). In response to the PS-Poll frame, the AP 210 may transmit the frame to STA1 220 (S231). After completing reception of the frame, STA1 220 is switched back to the sleep state and operates in the sleep state.

When the AP 210 transmits the beacon frame for the second time, the medium is in the busy state in which the medium is accessed by another device, and accordingly the AP 210 may not transmit the beacon frame at the correct beacon interval, but may transmit the beacon frame at as delayed time (S212). In this case, STA1 220 is switched to the awake state in accordance with the beacon interval, but does not receive the beacon frame whose transmission is delayed, and is thus switched back to the sleep state (S222).

When the AP 210 thirdly transmits the beacon frame, the beacon frame may include a TIM element set to a DTIM. However, since the medium is in the busy state, the AP 210 transmits the beacon frame at a delayed time (S213). STA1 220 may be switched to the awake state in accordance with the beacon interval and acquire the DTIM through the beacon frame transmitted by the AP 210. It is assumed that the DTIM acquired by STA1 220 indicates that there is no frame to be transmitted to STA1 220, but there is a frame for another STA. In this case. STA1 220 may confirm that there is no frame to receive and switch back to the sleep state to operate in the sleep state. After transmission of the beacon frame, the AP 210 transmits the frame to the corresponding STA (S232),

The AP 210 fourthly transmits the beacon frame (S214). STA1 220 may adjust the wakeup interval for reception of the TIM element since it has failed to acquire information indicating presence of buffered traffic for STA1 220 through the previous two operations of reception of the TIM element. Alternatively, provided that signaling information for adjustment of the value of the wakeup interval of STA1 220 is contained in the beacon frame transmitted by the AP 210, the wakeup interval value of the STA1 220 may be adjusted. In this example, STA1 220 may be set to be switched to the awake state once at every three beacon intervals to receive a TIM element, rather than being set to be switched between the operating states at every beacon interval. Therefore, when the AP 210 fifthly transmits the beacon frame (S215) after the fourth transmission of the beacon frame (S214), STA1 220 remains in the sleep state, and thus cannot acquire the corresponding TIM element.

When AP 210 sixthly transmits the beacon frame (S216), STA1 220 may be switched to the awake state and acquire the TIM element contained in the beacon frame (S224). Since the TIM element is a DTIM indicating presence of a broadcast frame, STA1 220 may receive the broadcast frame transmitted by the AP 210 without transmitting a PS-Poll frame to the AP 210 (S234). In the meantime, the wakeup interval set for STA2 230 may have a longer period than the wakeup interval of STA1 220. Accordingly, STA2 230 is switched to the awake state at a time point (S215) when the AP 210 fifthly transmits the beacon frame, such that the STA2 230 may receive the TIM element (S241). STA2 230 may recognize presence of a frame to be transmitted thereto through the TIM element and transmit the PS-Poll frame to the AP 210 in order to request frame transmission (S241a). The AP 210 may transmit a frame to STA2 230 in response to the PS-Poll frame (S233).

In order to operate/manage the PS mode as shown in FIG. 9, the TIM element includes a TIM indicating presence or absence of a frame to be transmitted to the STA or a DTIM indicating presence or absence of a broadcast/multicast frame. The DTIM may be implemented through field setting for the TIM element.

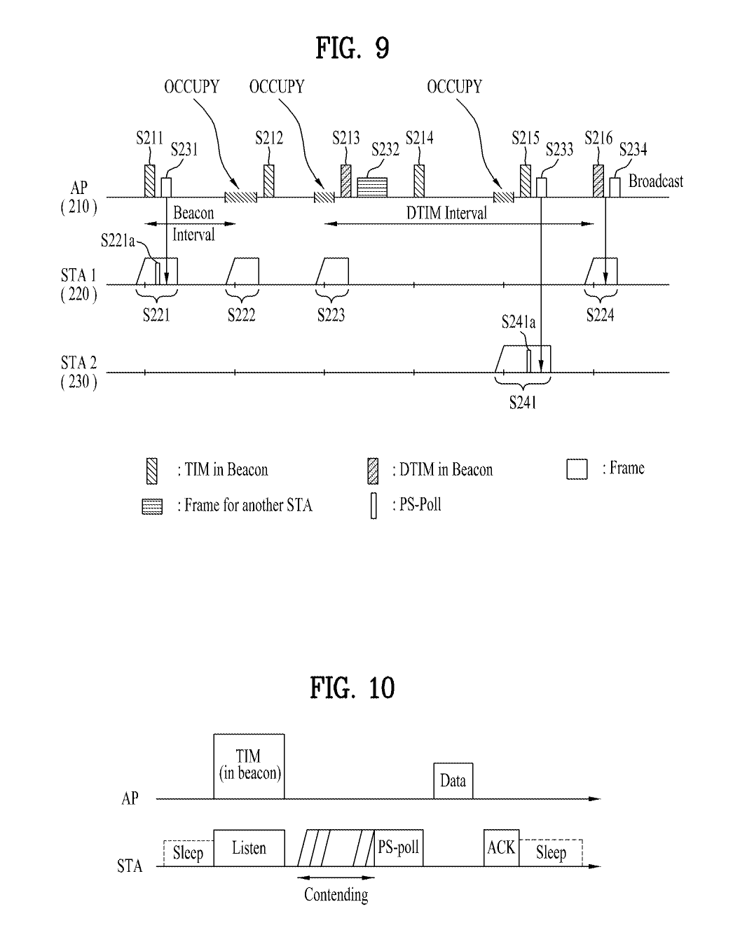

FIGS. 10 to 12 illustrate operations of an STA having received a TIM in detail.

Referring to FIG. 10, an STA is switched from the sleep state to the awake state to receive the beacon frame including a TIM from the AP. The STA may recognize presence of buffered traffic to be transmitted thereto by interpreting the received TIM element. After the STA contends with other STAs to access the medium for PS-Poll frame transmission, the STA may transmit a PS-Poll frame to the AP to request data frame transmission. The AP, upon receiving the PS-Poll frame transmitted from the STA, may transmit a data frame to the STA. The STA may receive the data frame and transmit an ACK frame to the AP in response to the received data frame. Thereafter, the STA may switch back to the sleep state.

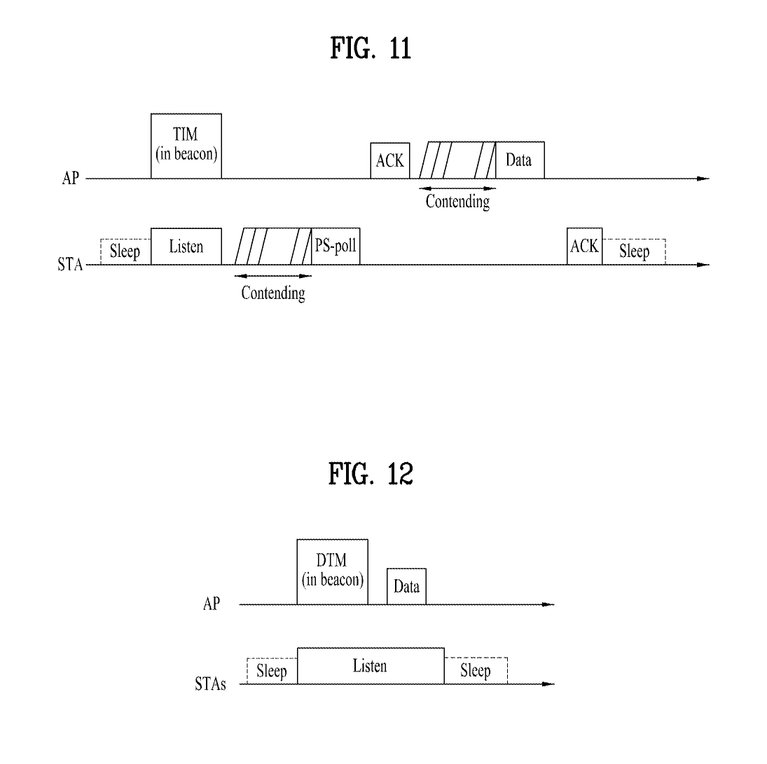

As shown in FIG. 10, the AP may operate in a manner of immediate response in which the AP transmits the data frame when a predetermined time (e,g., short inter-frame space (SIFS)) elapses after the AP receives the PS-Poll frame from the STA. However, the AP may operate in a manner of deferred response if the AP tails to prepare a data frame to be transmitted to the STA for the SIFS time after receiving the PS-Poll frame, which will be described in detail with reference to FIG. 11.

In the example of FIG. 11, the operations of the STA of switching from the sleep state to the awake state, receiving a TIM from the AP, and transmitting the PS-Poll frame to the AP through contention are identical to those in the example of FIG. 10. If the AP having received the PS-Poll frame fails to prepare a data frame for the SIFS time, the AP may transmit an ACK frame to the STA instead, of transmitting the data frame. If the data frame is prepared after transmission of the ACK frame, the AP may perform contention and transmit the data frame to the STA. The STA may transmit the ACK frame indicating successful reception of the data frame to the AP, and then be switched to the sleep state.

FIG. 12 shows an exemplary case in which AP transmits DTIM. STAs may be switched from the sleep state to the awake state so as to receive the beacon frame including a DIM element from the AP. The STAs may recognize, through the received DTIM, that a multicast/broadcast frame will be transmitted. After transmitting the beacon frame including the DTIM, the AP may immediately transmit data (i.e., a multicast/broadcast frame) without transmitting/receiving the PS-Poll frame. While the STAs continue to maintain the awake state even after receiving the beacon frame including the DIM, the STAs may receive data and then switch back to the sleep state after data reception is completed.

TIM Structure

In case of a method of managing a power saving mode based on the TIM (DTIM) protocol mentioned earlier with reference to FIGS. 9 to 12, STAs can check Whether or not there exists a data frame to be transmitted to the STAs via STA identification information included in a TIM element. The STA identification information may correspond to information related to an AID (association identifier) which is an identifier assigned to an STA when the STA is associated with an AP.

The AID is used as a unique identifier for each STA in a single BSS. As an example, the AID is assigned by a value among values ranging from 1 to 2007 in a current wireless LAN system. In a currently defined wireless LAN system, 14 bits can be assigned to a frame transmitted by an AP and/or an STA as the AID. Although a value of the AID can be assigned up to 16383, values ranging from 2008 to 16383 are configured as reserved values.

A TIM element according to a legacy definition is not suitable for being applied to an M2M application that many numbers (e.g., over 2007) of STAs are associated with a single AP. In case of expanding a legacy TIM structure as it is, since a size of a TIM bitmap becomes too large, it is unable to support with a legacy frame format and it is not appropriate for M2M communication considering an application of a low transmission rate. And, it is expected that the number of STAs in which a reception data frame exists during a single beacon interval is very small in M2M communication. Hence, in case of considering the aforementioned M2M communication application example, although a size of a TIM bitmap is enlarged, it is expected a case that most of bits has a value of 0 frequently occurs. Thus, a technology of efficiently compressing a bitmap is required.

As a legacy bitmap compression technology there is a method of omitting contiguous 0's at the forepart of a bitmap and defining by an offset (or start point) value. Yet, if the number of STAs in which a buffered frame exists is less and a difference of an AID value of each STA is big, a compression efficiency of the method is not high. For example, when a frame, which is to be transmitted to 2 STAs respectively including an AID of 10 and an AID of 2000, is buffered only, although a length of a compressed bitmap corresponds to 1990, all bits have a value of 0 except both ends. If the number of STAs capable of being associated with a single AP is less, inefficiency of bitmap compression is not a big problem. Yet, if the number of STAs increases, the inefficiency may become an element deteriorating overall system performance.

As a method of solving the aforementioned problem, data transmission can be more efficiently performed in a manner of dividing an AID into a plurality of groups. A designated group ID (GID) is assigned to each of a plurality of the groups. The AID assigned based on a group is explained with reference to FIG. 13 in the following.

FIG. 13(a) is a diagram for an example of an AID assigned based on a group. Referring to the example of FIG. 13(a), several bits at the front of an AID bitmap can be used to indicate a GID. For example, first 2 bits of the AID bitmap can be used for indicating 4 GIDs. When the total length of an AID bitmap corresponds to N bits, a value of first 2 bits (B1 and ‘B2) indicates a GID of the AID.

FIG. 13(b) is a diagram for a different example of an AID assigned based on a group. Referring to the example of FIG. 13(b), a GID can be assigned according to at position of an AID. In this case AIDs using an identical GID can be represented by a value of an offset and a length. For example, if a GID 1 is represented by an offset A and a length B, it means that AIDs ranging, from A to A+B−1 have the GID 1 on a bitmap. For example, in the example of FIG. 13(b), assume that the total AIDs ranging from 1 to N4 are divided into 4 groups. In this case, AIDs belonging to the GID 1. correspond to AIDs ranging from 1 to N1 and the AIDs belonging to the GID 1 can be represented by an offset 1 and a length N1. AIDs belonging to a GID 2 can be represented by an offset N1+1 and a length N2−N1+1, AIDs belonging to a GID 3 can be represented by an offset N2+1 and a length N3−N2+1 and AIDs belonging to a GID 4 can be represented by an offset N3+1 and a length N4−N3+1,

As mentioned in the foregoing description, if an AID assigned based on a group is introduced, it is able to make channel access to be permitted in time section different from each other according to a GID. Hence, a TIM element deficiency problem for many numbers of STAs is solved and data can be efficiently transmitted and received. For example, channel access is permitted for STA(s) belonging to a specific group only during specific time section and the rest of STA(s) may have restriction on the channel access, prescribed time section for which access is permitted for specific STA(s) may be called a RAW (restricted access window).

A channel access according to a GID is explained with reference to FIG. 13(c), FIG. 13(c) shows an example of a channel access mechanism according to a beacon interval when an AID is divided into 3 groups. A first beacon interval (first RAW) corresponds to an interval for which a channel access of an STA corresponding to an AID belonging to a GID 1 is permitted. Channel access of STAs belonging to a different GID is not permitted. To this end, A TIM element for AIDs corresponding to the GID 1 is included in the first beacon only. A TIM element for AIDs including a GID 2 is included in a second beacon frame. Hence, channel access of STAs corresponding to AIDs belonging to the GID 2 is permitted only during a second beacon interval (second RAW). A TIM element for AIDs including a GID 3 is included in a third beacon interval only. Hence, channel access of STAs corresponding to AIDs belonging to the GID 3 is permitted only during a third beacon interval (third RAW). The TIM element for the AIDs including the GID 1 is included again in a fourth beacon interval only. Hence, channel access of the STAs corresponding to the AIDs belonging to the GID 1 is permitted only during a fourth beacon interval (fourth RAW). Channel access of an STA belonging to a specific group, which is indicated by a TIM included in a corresponding beacon frame, is permitted only during each of beacon intervals after a fifth beacon interval (each of RAWs after a fifth RAW).

FIG. 13(c) shows an example of a circular or periodical order of a GID which is permitted according to a beacon interval, by which the present invention may be non-limited. In particular, if AID(s) belonging to a specific GID(s) is included in a TIM element, channel access of STA(s) corresponding to the specific AID(s) can be permitted during specific time interval (specific RAW) and channel access of the rest of STA(s) may not be permitted during the specific time interval,

As mentioned in the foregoing description, the group-based AID assignment scheme can also be called a hierarchical structure of a TIM. In particular, a total AID space is divided into a plurality of blocks and it is able to make channel access of STA(s) (i.e., STA of a specific group) corresponding to a specific block including a value except 0 to be permitted only. By doing so, a TIM of a large size is divided into a small blocks/groups, an STA can easily maintain TIM information and the blocks/groups can be easily managed according to a class of an STA, service quality (QoS), or a usage. Although the example shown in FIG. 13 shows a 2-level layer, it is able to configure a TIM of a hierarchical structure in a form equal to or greater than the 2 levels. For example, a total AID space is divided into a plurality of page groups, each page group is divided into a plurality of blocks and each block can be divided into a plurality of sub-blocks, in this case, as an extended example of the example shown in FIG. 13(a), in an AID bitmap, fast N1 number of bits indicate a page ID (i.e., PID), next N2 number of bits indicate a block ID, next N3 number of bits indicate a sub-block ID and the remaining bits can indicate an STA bit position in a sub-block.

In the examples of the present invention described in the following, it is able to apply various methods of dividing STAs (or AIDs assigned to each of the STAs) in a prescribed hierarchical group unit and managing the STAs. A group-based AID assignment scheme may be non-limited by the examples.

Frame Structure

FIG. 14 is a diagram for explaining an example of a frame structure used in IEEE 801.11 system

PPDU (Physical Layer Convergence Protocol (PLCP) Packet Data Unit) frame format can be configured by including an HSTF (Short Training Field), an LTF (Long Training Field), an SIG (SIGNAL) field and a data filed. A most basic (e.g., non-HT (High Throughput)) PPDU frame format can be configured by an L-STF (Legacy-STF), an L-LTF (Legacy-LTF), an SIG field and a data field only. And, an additional (or a different type) STF, an LTF and an SIG field can be included between the SIG field and the data field according to a type (e.g., a HT-mixed format PPDU, a HT-greenfield format PPDU, a VHT (Very High Throughput) PPDU, etc.) of the PPDU frame format.

The STF corresponds to a signal for performing signal detection, AGC (automatic gain control), diversity selection, delicate time synchronization and the like. The LTF corresponds to a signal for performing channel estimation, frequency error estimation and the like. Both the STF and the LTF can be commonly called a PCLP preamble. A PLCP preamble may correspond to a signal for performing synchronization of an OFDM physical layer and channel estimation,

The SIG field can include a RATE field, a LENGTH field and the like. The RATE field can include information on data modulation and coding rate. The LENGTH field can include information on a length of data. In addition, the SIG field can include a parity bit, an SIG TAIL bit and the like.

The data field can include a SERVICE field, a PSDU (PLCP service data unit) and as PPDU TAIL bit. If necessary, the data field can also include to padding bit. A part of bits of the SERVICE field can be used by a receiving end for synchronization of a descrambler. The PSDU corresponds to a MAC PDU (protocol data unit) defined in a MAC layer and can include data generated/used in a higher layer. The PPDU TAIL bit can be used to make an encoder return to 0 state. The padding bit can be used to match a length of a data field with a prescribed unit.

The MAC PDU is defined according to various MAC frame formats. A basic MAC frame consists of a MAC header, a frame body and a FCS (frame check sequence). A MAC frame is configured by a MAC PDU and can be transmitted and received via a PSDU corresponding to a data part of a PPDU frame format.

The MAC header can include a frame control field, a duration/ID field, an address field and the like. The frame control field can include control information necessary for transmitting/receiving a frame. The duration/ID field can be configured by time necessary for transmitting a corresponding frame and the like. For details of a sequence control, QoS control, and HT control subfields of the MAC header, it may refer to IEEE 802.11-2012 standard document.

The frame control field of the MAC header can include such a subfield as Protocol Version, Type, Subtype, To DS, From DS, More Fragment, Retry, Power Management, More Data, Protected Frame, and Order. For contents of the each subfield of the frame control field, it may refer to IEEE 802.11-2012 standard document.

Table 1 shown in the following shows explanation on the To DS subfield and the From DS subfield within the frame control field defined by a legacy IEEE 11ac standard.

TABLE 1

| To DS and | |
|---|---|
| From DS values | Meaning |
| To DS = 0, | A data frame direct from one STA to another STA |
| From DS = 0 | within the same IBSS, a data frame direct from one |
| | non-AP STA to another non-AP STA within the |
| | same BSS, or a data frame outside the context of a |
| | BSS, as well as all management and control frames. |
| To DS = 1, | A data frame destined for the DS or being sent by a |
| From DS = 0 | STA associated with an AP to the Port Access |
| | Entity in that AP. |
| To DS = 0, | A data frame exiting the DS or being sent by the |
| From DS = 1 | Port Access Entity in an AP. |
| To DS = 1, | A data frame using the four-address format. This |
| From DS = 1 | standard does not define procedures for using this |
| | combination of field values. |

4 address fields (Address 1, Address 2, Address 3, and Address 4) of a MAC header can be used for indicating a BSSID (Basic Service Set Identifier), an SA (Source Address), a DA (Destination Address), a TA (Transmitter Address), an RA (Receiver Address) and the like and may be able to include a part of the 4 address fields only depending on a frame type. A usage of the address field can be specified by a relative position of the address field (address 1-address 4) in a MAC header irrespective of a type of an address of the field. For example, an address of a receiver can always be checked on the basis of content of an address 1 field of a received frame. A receiver address of a CTS frame can always be obtained from an address 2 field of an RTS frame corresponding to the CTS frame. A receiver address of an ACK frame can always be obtained from an address 2 field of a frame becoming a target of an acknowledgement response. Table 2 shown in the following explains contents of the address fields (address 1-address 4) of the MAC header according to a value of the To DS subfield and a value of the From DS subfield in the frame control field of the MAC header.

TABLE 2

| | | | | Address 3 | | Address 4 | |
|---|---|---|---|---|---|---|---|
| To | From | | | | A-MSDU | | A-MSDU |
| DS | DS | Address 1 | Address 2 | MSDU case | case | MSDU case | case |
| 0 | 0 | RA = DA | TA = SA | BSSID | BSSID | N/A | N/A |
| 0 | 1 | RA = DA | TA = BSSID | SA | BSSID | N/A | N/A |
| 1 | 0 | RA = BSSID | TA = SA | DA | BSSID | N/A | N/A |
| 1 | 1 | RA | TA | DA | BSSID | SA | BSSID |

In Table 2, an RA indicates a receiver address, a TA indicates a transmitter address, a DA indicates a destination address and an SA indicates a source address. And, an MSDU indicates a MAC SDU (service data unit) corresponding to a unit of information delivered between MAC SAPs (service access points). An A-MSDU indicates a frame format delivering a plurality of SDUs via a single MAC PDU. Values of the address field (address 1, address 2, address 3 or address 4) can be configured by to form of an Ethernet MAC address of 48-bit size.

Meanwhile, a null-data packet (NDP) frame format indicates a frame format of a form not including a data packet. In particular, the NDP frame format corresponds to a frame format including a PLCP header part (i.e., STF, LTF and SIG field) only in a general PPDU format and the frame format not including the remaining part (i.e., as data field). The NDP frame format can also be called a short frame format.

Duplicate Detection

Since MAC level acknowledgement and retransmission are defined as a protocol, it is probable to receive a frame more than one time. In this case, a duplicated frame should be filtered out. In order to filter out a duplicated frame, it may use a sequence control field of a MAC header. The sequence control field includes a sequence number and a fragment number in a data frame and a management frame. MPDUs corresponding to parts of an identical MSDU have an identical sequence number and MSDUs different from each other have a sequence number different from each other,

An STA assigns a sequence number of as frame according to a counter (e.g., a modulo-4096 counter starting from 0) increasing by 1 for every new MSDU. An STA transmitting a frame stores (caches) a lastly used sequence number according to a receiver address (RA).

An STA receiving a frame caches a transmitter address (TA) of a most recently received frame, a sequence number and a set of fragment numbers. The TA can be determined based on a value of an address 2 filed of a received frame. If a retry field of a frame control field is set to 1 and a frame including a same sequence number (or a same fragment number) is received from an identical TA, a reception STA determines it as a duplicated frame and may be able to reject the frame.

MAC Header Compression Method

The present invention proposes a compression method of a MAC header to perform communication with low power. For example, the MAC header compression method proposed by the present invention uses a channel bandwidth such as 1 MHz, 2 MHz, 4 MHz, 8 MHz or 16 MHz and the MAC header compression method can be applied, to a wireless LAN system operating on a frequency band below 1 GHz (sub 1 GHz, hereinafter, S1G).

As mentioned earlier with reference to FIG. 14, a MAC header is mandatorily included in a frame for transmitting data, if a size of the MAC header is reduced (i.e., in case of reducing overhead of the MAC header), such an operation as generation of a MAC frame, transmission of the MAC frame, reception of the MAC frame of an STA can be more simplified. Consequently, power consumed by the STA can be reduced.

A wireless LAN system (e.g., a system according to IEEE 802.11ah standard) operating on Sub 1 GHz (S1G) band has a characteristic of operating on as low frequency band and a characteristic that coverage at which a frame is arrived reaches as much as 1 kilometer in outdoor environment. The wireless LAN system mainly defines an operation of an STA of a sensor type or a meter type characterized by a low transfer rate and low power.

A power saving mechanism is absolutely important for the STAs of the sensor type. It is necessary for the STA to minimize an unnecessarily awakened situation to save power, it is necessary for the STA to efficiently transmit data during a period of waking up.

Hence, it is required to configure a frame capable of consuming low power while a tong-range transmission is supported for the wireless LAN system operating on the S1G band. In order to implement a frame supporting the long-range transmission, it may consider a method of repeating fields of a frame more than double in a time axis or a frequency axis. Yet, if a field is repeatedly coded, a size of a MAC header increases and a problem of increasing power consumption of an STA to process a frame may occur.

Hence, in order to solve the problem, the present invention proposes a MAC header compression method. To this end, first of all, a scheme of configuring a frame in a wireless LAN system operating on the S1G hand is explained.

By the nature of a radio wave, communication on the S1G band has considerably wider coverage compared to a legacy wireless LAN system performed mainly in indoor. The communication on the S1G band can be implemented in a form of down-clocking PHY defined in legacy IEEE 802.11ac system as much as 1/10. In this case, down-clocking is performed on 20/40/80/160/80+80 MHz channel bandwidth supported by the 802.11ac system as much as 1/10 and it may be then able to provide 2/4/8/16/8+8 MHz on the S1G band. Hence, as GI (guard interval) increases as much as 10 times from 0.8 μs of the 802.11ac system to 8 μs.

Since a previously operating legacy device does not exist on the S1G band, it is important to efficiently design a PHY preamble on the S1G band as much as possible without considering backward compatibility. A most easy way is to design an S1G PHY preamble in a manner of down-clocking a previously defined HT-GreenField PLCP frame format (refer to IEEE 802.11n standard) as much as 1/10. For example, the structure can be used for a bandwidth equal to or greater than 2 MHz.

In order to support long-range communication, it may be able to configure a long-range PLCP frame in a manner of repeating STF/LTF/SIG/DATA fields of a frame format of an S1G PHY structure, which is used for the bandwidth equal to or greater than 2 MHz, as much as more than twice in a time axis or a frequency axis.

FIG. 15 is a diagram for explaining an example of a long-range PLCP frame format.

Similar to a Green-field format defined in IEEE 802.11n, a PLCP frame format shown in FIG. 15 consists of an STF aft LTF1, an SIG, an LTF2-LTFN and a data field. Yet, the PLCP frame format can be comprehended as a form that transmission time of a preamble part is increased more than twice compared to the Green-field format as a result of repeating the frame format. The PLCP frame format shown in an example of FIG. 15 can be used for 1 MHz bandwidth and can be called a 1 MHz PPDU format.

Although an STF field of 1 MHz PPDU shown in FIG. 15 has a periodicity identical to an STF (2-symbol length) of a PPDU for a bandwidth equal to or greater than 2 MHz, if a scheme of repeating twice (rep2) is applied in time axis, the STF field of 1 MHz PPDU has 4-symbol length (e.g., 160 μs) and 3 dB power boosting is applied.

An LTF1 field of the 1 MHz PPDU shown in FIG. 15 is designed to be orthogonal to an LTF1 field (2 symbol length) of a PPDU for a bandwidth equal to or greater than 2 MHz in frequency domain. The LTF1 field of the 1 MHz PPDU is repeated twice in time axis and has 4-symbol length,

An SIG field of the 1 MHz PPDU shown in FIG. 15 can be repeatedly coded. As an MCS (modulation and coding scheme), QPSK (Quadrature Phase Shift Keying), BPSK (Binary PSK) and the like can be applied to an SIG field of a PPDU for a bandwidth equal to or greater than 2 MHz and the SIG field of the PPDU has a length of 2 symbols. On the contrary, a lowest MCS (i.e., BPSK) and repetition coding (rep2) are applied to the SIG field of the 1 MHz PPDU, a rate of the SIG field of the 1 MHz PPDU is configured by 1/2, and the SIG field of the 1 MHz PPDU can be defined by a length of 6 symbols.

An LTF2 field to an LTFN field of the 1 MHz PPDU shown in FIG. 15 can be included in case of MIMO. Each of the LTF fields has a length of 1 symbol.

A repetition scheme may or may not be applied to a data field of the 1 MHz PPDU shown in FIG. 15.

FIG. 16 is a transmission flow for explaining a repetition scheme to configure a PLCP frame format for 1 MHz bandwidth.

A scrambler shown in FIG. 16 can scramble data to lower a probability of repeating 0 or 1 for a long time, FEC (forward error correction) can encode data to correct an error. To this end, the FEC can include a binary convolution encoder or an LDPC (low density parity check) encoder.

2x block-wise repetition can output 2 number of information bits in a manner of repeating x number of encoded information bits of each OFDM symbol in a block unit (if an encoding rate corresponds to 1/2, x/2 number of information bit is encoded in each OFDM symbol and x number of encoded information bit can be generated). If a lowest MSC (e.g., MCS0) in an SS (spatial stream) is applied after the repetition, it is able to include N_{CBPS} number of coded bits per a symbol

An interleaver can perform interleaving (position change) to prevent a noise bit adjacent to a decoder from being contiguous for a long time. A BPSK mapper can convert (map to a complex symbol) an encoded data bit into a BPSK constellation point. In spatial mapping, time-space streams can be mapped to transmission chains, an IDFT (inverse discrete Fourier transform) can convert complex symbols into a time domain blocks. A GI & Window can perform an operation of implementing as guard interval (GI) in a manner of appending a part of a symbol itself to a front of a corresponding symbol (prepend) and perform windowing for increasing a spectral decay by smoothing edges of each of symbols. Analog and RF (radio frequency) can generate a transmission symbol.

Fragment Block ACK Method

If 1 MHz PPDU frame is configured using the aforementioned method, since transmission time of a frame (e.g., a long frame) is too extended, as transmission rate is reduced and power consumption of an STA may increase. In order to solve the problem, if transmission time is too long, the frame (e.g., a long frame) can be transmitted in a manner of being fragmented into a plurality of short frames. In this case, the present invention proposes a method of retransmitting each of a plurality of the fragmented frames using a block ACK scheme.

It is necessary to note that the fragment block ACK scheme proposed by the present invention corresponds to a block ACK scheme for a plurality of fragmented frames distinguished from a block ACK scheme for a legacy A-MPDU (aggregate-MPDU).

For example, in a band below 1 GHz bans (Sub 1 GHz), if a channel bandwidth is relatively narrow such as 1, 2, 4, or 16 MHz, transmission time of a frame becomes longer. If the transmission time becomes longer, a packet error rate is relatively increasing in an identical SINR (signal to interference-plus-noise ratio), in this environment, it is preferable to configure a short frame in a manner of fragmenting an MSDU or an MMPDU (Mac Management Protocol Data Unit) to be transmitted.

In the present invention, if a length of an MSDU or an MMPDU to be transmitted is greater than a prescribed threshold, a transmission UE can perform an operation of fragmenting the MSDU or the MMPDU. Each of fragmented frames can be independently transmitted. For example, assume a case that a single MSDU is fragmented into 5 fragment frames (e.g., fragment 1, fragment 2, fragment 3, fragment 4 and fragment 5). In this case, all of the fragment 1, the fragment 2, the fragment 3, the fragment 4 and the fragment 5 are transmitted with an SIFS interval and it is able to receive a block ACK frame from a reception UE. If an error occurs on a part of the fragment frames, it is able to retransmit a corresponding fragment frame on which the error has occurred. For example, if a reception error occurs on the fragment 2 and the fragment 4, the reception UE recognizes a fact of error occurrence via a bitmap of a block ACK transmitted by the transmission UE and performs retransmission for the fragment 2 and the fragment 4 only. In particular, it is not necessary to sequentially transmit all fragment frames all the time.

In order to independently transmit the fragment frames, each of the fragment frames indicates a following operation of a UE, which has received the corresponding fragment frame, via an ACK policy value of a MAC header. For example, if a transmitted fragment frame is not a last fragment frame, the fragment frame configures the ACK policy value of the MAC header as a block ACK value, informs a reception UE that a different fragment frame is to be transmitted in succession, and makes the reception UE ready for a block ACK bitmap. If a transmitted frame corresponds to a last fragment frame, an ACK policy value of a MAC header of the fragment frame is configured as an implicit block ACK request value and it is able to request to transmit a block ACK frame with an SIFS interval thereafter.

Information on whether or not a frame corresponds to a fragment frame is identified by a value of a More Fragments field of a MAC header and a Fragment Number value of a Sequence Number field in a sequence control field. If a value of the More Fragments field of the MAC header corresponds to 1, it means that a different fragment frame is to be transmitted in succession. If a value of the More Fragments field of the MAC header corresponds to 0, it means that a different fragment frame is not transmitted anymore. The Fragment Number value of the Sequence Number field in the sequence control field of the MAC header starts from 0, increases by 1 for every fragment frame and plays a role in identifying a fragment frame in which an error occurs after the transmission UE receives a block ACK.

TABLE 3

| ACK | | | |
|---|---|---|---|
| Policy | PPDU | | |
| field | Type | ACK Policy | |
| 0 | MPDU | No ACK | |
| 1 | MPDU | (NDP) ACK | |
| 0 | A-MPDU | (NDP) Block ACK or | |
| 1 | A-MPDU | Implicit (NDP) | |
| | | Block ACK Request | |
| 0 | Fragment | (NDP) ACK | More Fragment == 1 |
| | MPDU | | |
| 1 | Fragment | (NDP) Block ACK | More Fragment == 1 |
| | MPDU | | |
| 0 | Fragment | (NDP) ACK | More Fragment == 0 && |
| | MPDU | | Fragment Number > 0 |
| 1 | Fragment | Implicit (NDP) | More Fragment == 0 && |
| | MPDU | Block ACK Request | Fragment Number > 0 |

Table 3 shows detailed examples of configuring an ACK policy field value and an ACK policy of a reception UE configured in response to the ACK policy field value in a fragment block ACK method proposed by the present invention.

It is able to see that (NDP) ACK, (NDP) Block ACK, and Implicit (NDP) Block ACK Request are configured as an ACK Policy of a reception UE by a value of ACK Policy field. Yet, in order to distinguish a fragment block ACK method from a legacy normal ACK-based fragment scheme, the ACK Policy of the reception UE can be configured using a value of the More Fragment field or using both the value of the More Fragment field and a Fragment Number value at the same time.

In particular, although the ACK Policy of the reception UE is determined by a value of the ACK Policy field for an MPUD or an A-MPDU, in case of a fragment MPDU, the ACK Policy of the reception UE is determined using not only the ACK Policy field but also the More Fragment field and/or the Fragment Number field.

Specifically, if a value of the ACK Policy field of the Fragment MPDU corresponds to 0 and a value of the More Fragment field corresponds to 1, it is indicated to respond by (NDP) ACK. If a value of the ACK Policy field of the Fragment MPDU corresponds to 1 and a value of the More Fragment field corresponds to 1, it is indicated to respond by (NDP) Block ACK. If a value of the ACK. Policy field of the Fragment MPDU corresponds to 0, a value of the More Fragment field corresponds to 0 and the value of the Fragment Number is greater than 0, it is indicated to respond by (NDP) ACK. If a value of the ACK Policy field of the Fragment MPDU corresponds to 1, a value of the More Fragment field corresponds to 1 and the value of the Fragment Number is greater than 0, Implicit (NDP) Block ACK Request is indicated.

In order to distinguish the fragment block ACK method from the legacy normal ACK-based fragment scheme, it may be able to apply a different scheme. For example, capability exchange between UEs can be used for distinguishing the schemes from each other. If both a transmission UE and a reception UE support the fragment block ACK method, ACK Policy field value of a fragment frame indicates either block ACK or Implicit Block ACK request. Otherwise (i.e., if one of the transmission UE and the reception UE does not support the fragment block ACK), the ACK Policy field value of the fragment frame indicates an ACK scheme identical to the Normal ACK scheme

In the following, a scheme of transmitting a fragment frame by encrypting the fragment frame is explained.

FIG. 17 is a block diagram for explaining CCMP encapsulation.

In IEEE 802.11 system, it may be able to use a TKIP (Temporal Key Integrity Protocol), a CCMP (Counter mode with Cipher-block chaining Message authentication code Protocol) and the like to encrypt a MAC frame. The CCMP is proposed by IEEE 802.11i standard. The CCMP is an enhanced cryptographic encapsulation method designed for data confidentiality based on CCM of an AES (Advanced Encryption Standard).

A security mechanism of IEEE 802.11 system can be provided to a data frame and a management frame. Specifically, data confidentiality, authentication, integrity; replay protection and the like can be provided using TKIP, CCMP, etc.

Referring to an example of FIG. 17, an encrypted MPDU can be obtained from a payload of a plaintext MPDU.

Specifically, a new PN value for each MPDU can be obtained by incrementing a packet number (PN).

additional authentication data (ADD) for CCM can be configured using fields of a MAC header of a plaintext MPDU. A CCM algorithm can provide integrity protection to fields included in the AAD. The AAD can include an FC (frame control) field of an MPDU, an A1 (address 1) field, an A2 (address 2) field, an A3 (address 3) field, an SC (sequence control) field, an A4 (address 4) field, and a QC (QoS control) field.

A CCN Nonce can consist of a PN value, an A2 (address 2) field of an MPDU and a priority value. Nonce indicates a number or a bit string used in a security algorithm one time only.

A PN value and a key identifier (KeyId) value form an 8-octet CCMP header.

Encrypted data and an MIC (message integrity code) are formed using a TK (temporary key), AAD, Nonce and MPDU data.

An encrypted MPDU is formed by combining an original MPDU header, a generated CCMP header, a generated encrypted data and a MIC with each other.

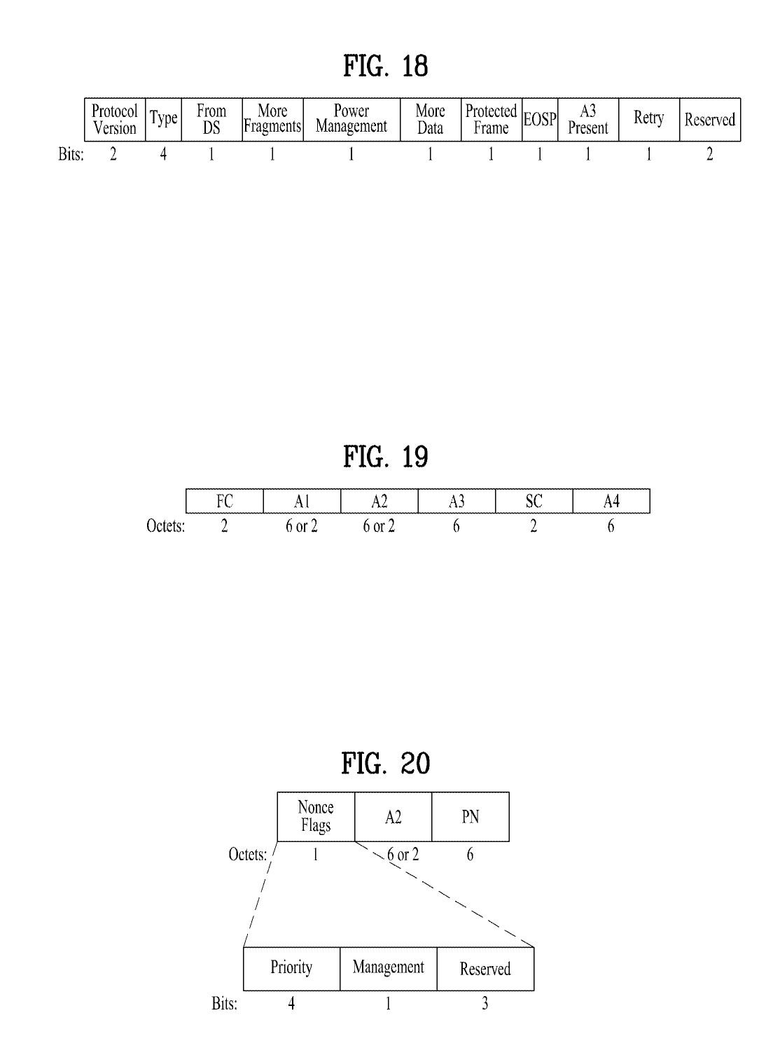

FIG. 18 is a diagram for an exemplary configuration of a frame control field of a short MAC header according to the present invention.

A part of subfields of an FC (frame control) field of a short MAC header shown in FIG. 18 can be configured to be different from subfields of a normal MAC header mentioned earlier in FIG. 14. For example, compared to the normal MAC header, a type field of the FC field of the short MAC header has a 4-bit size and does not include a subtype field. And, compared to the normal MAC header, the FC field of the short MAC header does not include a To DS field and an Order field. And, compared to the normal MAC header, the FC field of the short MAC header includes an EOSP (End Of Service Period) field.

As shown in an exemplary format of the FC field of the short MAC header shown in FIG. 18, the FC field of the short MAC header according to the present invention includes a Protocol Version field (2 bits), a Type field (4 bits), a From DS field (1 bit), a More Fragments field (1 bit), a Power Management field (1 bit), a More Data field (1 bit), a Protected Frame field (1 bit) and an EOSP field (1 bit).

As mentioned earlier in FIG. 17, AAD is configured using fields of a MAC header. A method of configuring an AAD in case of using the FC field of the short MAC header mentioned in FIG. 1$ is explained in the following with reference to FIG. 19.

FIG. 19 is a diagram for an exemplary configuration of AAD according to the present invention.

In an example of FIG. 19, an PC corresponds to a frame control field and may have a 2-octet size.

The FC field of AAD can be configured according to an FC field of a short MAC header mentioned earlier in FIG. 18. In this case, a Type bit of an FC field of a data MPDU can be masked to 0 in the AAD.

If a frame is in a fragmented state and the frame is transmitted according to a fragment block ACK method proposed by the present invention, as More Fragment bit of the FC field can be masked to 0 in the AAD. This is because if a value of the More Fragment bit is different from each other in initial transmission and retransmission, a problem may occur in terms of security. Hence, although the More Fragment bit corresponds to 1 in the initial transmission, the bit is forcibly configured by 0 in the retransmission. This can be identically applied not only to AAD configuration but also to Nonce configuration described later.

And, a Power Management field of the FC field can be masked to 0 in the AAD.

And, a More Data bit of the FC filed can be masked to 0 in the AAD.

And, a Protected Frame bit of the FC field can always set to 1 in the AAD.

And, an EOSP bit of the FC field can be masked to 0 in the AAD.

And, a Retry bit of the FC field can be masked to 0 in the AAD.

In this case, when a field is masked to 0, it can be comprehended as the field is not used although the field is included in the AAD.

A1, A2. A3 and A4 respectively correspond to Address 1, Address 2, Address 3 and Address 4 of each MPDU. The A1 field may have a 6-octet or 2-octet size. The A2 field may have a 6-octet or 2-octet size. The A3 and the A4 field may have a 6-octet size, respectively.

In this case, a short MAC header omits one or more fields among the A3 and the A4 field and always includes the A1 field (i.e., RA) and the A2 field (i.e., TA). And, if the A1 field is configured by an MAC address or a BSSID, the A1 field has a 6-octet size. If the A1 field is configured by an AID, the A1 field may have a 2-octet size. If the A2 field is configured by an MAC address or a BSSID, the A2 field has a 6-octet size. If the A2 field is configured by an AID, the A2 field may have to 2-octet size.

Similarly, one of the A3 and the A4 field or both the A3 and the A4 field can be omitted in AAD as well. For example, if the A3 is omitted from a short MAC header, the AAD can consist of FC, A1, A2, A4 and SC. Or, if the A4 is omitted from a short MAC header, the AAD can consist of FC, A1, A2, A3 and SC. Or, if the A3 and the A4 are omitted from a short MAC header, the AAD can consist of FC, A1, A2 and SC.

In this case, the A1 field of the AAD may have a 6-octet or 2-octet size.

Specifically, the A1 field of the AAD is configured according to an Address 1 field of an MPDU. The A1 field of the AAD can be configured by an AID (2 octets) or an MAC address (6 octets) according to a frame direction (e.g., uplink frame or downlink frame). In case of a downlink frame of which a From DS bit of the FC field of the short MAC header is set to 1 (In this case, as From DS bit of the FC field of the AAD is also set to 1), the A1 field of the AAD is configured by an AID (2 octets) value of a reception STA. In case of an uplink frame of which the From DS bit of the FC field of the short MAC header is set to 0 (In this case, the From DS bit of the FC field of the AAD is also set to 0), the A1 field of the AAD is configured by an MAC address of the reception STA (or an AP) or a BSSID (6 octets).

And, the A2 field of the AAD may have a 6-octet or 2-octet size.

Specifically, the A2 field of the AAD is configured according, to an Address 2 field of an MPDU. The A2 field of the AAD can be configured by an AID (2 octets) or an MAC address (6 octets) according to a frame direction (e.g., uplink frame or downlink frame). In case of a downlink frame of which a From DS bit of the FC field of the short MAC header is set to 1 (In this case, a From DS bit of the FC field of the AAD is also set to 1), the A2 field of the AAD is configured by an MAC address of a transmission STA (or an AP) or a RSSID (6 octets). In case of an uplink frame of which the From DS bit of the FC field of the short MAC header is set to 0 (In this case, the From DS bit of the FC field of the AAD is also set to 0), the A2 field of the AAD is configured by an AID (2 octets) of the transmission STA.

The A3 field, if present, is configured according to an Address 3 field of an MPDU. And, an A3 Present bit of the AAD can indicate whether or not the A3 field is included in a compressed MAC header or the AAD. And, the A4 field, if present, is configured according to an Address 4 field of an MPDU.

The SC corresponds to a sequence control field and may have a 2-octet size. The SC field of an AAD can be configured according to a Sequence Control field of an MPDU.

In this case, as mentioned earlier in the duplicate detection section, a Sequence Control field of an MAC header consists of a Sequence Number and a Fragment Number subfield and an SC field of an AAD also consists of a Sequence Number and a Fragment Number subfield. The Sequence Number and the Fragment Number subfield of the SC field of the AAD can be masked to 0. The Fragment Number subfield of the SC field of the AAD is not modified compared to the Fragment Number subfield of the SC field of the MAC header.

An order of the configuration elements of the AAD is not limitative. It is necessary to understand that the AAD configured according to the present invention includes a part of the subfields described in FIG. 19.

When an AAD is configured according to the proposal proposed by the present invention, in case of supporting a fragment block ACK method, it is necessary to note that a More Fragment field is masked to 0. For example, assume a case that a transmission UE transmits a fragment 1, a fragment 2, a fragment 3, a fragment 4 and a fragment 5 with an SIFS interval and receives a block ACK frame from a reception UE. In this case, assume a case that a More Fragment field of each of the fragment 1, the fragment 2, the fragment 3, and the fragment 4 has a value of 1 and a More Fragment field of the fragment 5 has a value of 0. if a reception error occurs on the fragment 2 and the fragment 4, the transmission UE recognizes the fact via a bitmap of a block ACK transmitted from the reception UE and performs retransmission for the fragment 2 and the fragment 4 only. In this case, the More Fragment field of the fragment 2 has a value of 1 and the More Fragment field of the fragment 4 has a value of 0. Specifically, this is because the fragment 4 becomes a last fragment in case of performing retransmission. In this case, the reception UE receives the fragment 4 and responds to the Block ACK frame after an SIFS interval elapses. In case of the Fragment 4, it is able to see that the More Fragment field value of the first transmission (i.e., 0 and the More Fragment value of the retransmission (i.e., 1) are different from each other. Hence, in order to permit selective retransmission to an encrypted fragment frame via a block ACK, a More Fragment bit of an MAC header should be masked to 0 in case of configuring an AAD.

FIG. 20 is a diagram for an exemplary configuration of Nonce according to the present invention.

As shown in an example of FIG. 20, Nonce can include a Nonce flags field, an A2 (Address 2) field and as PN field. The Nonce flags field may have a 1-octet size. The A2 field may have a 6-octet or 2-octet size. The PN field may have a 6-octet size.

FIG. 20 additionally shows a specific configuration of the Nonce Flags field. The Nonce Flags field can consist of 4 bits for a Priority subfield, 1 bit for Management subfield and reserved 3 bits.

A Priority field of the Nonce Flags field can be configured by a value indicating Priority of a short MAC frame. For example, the Priority field can be configured by a value indicating a TID (Traffic Identifier) of as plaintext MPDU or an Access Category.

A Management field of the Nonce Flags field can be configured by a value indicating whether or not a plaintext MPDU corresponds to a Management Frame.

The A2 field of the Nonce can be configured based on the Address 2 field of as short MAC header. The A2 field of the Nonce can be configured by an AID (2 octets) of a transmission STA or an MAC address (6 octets) according to a frame direction (e.g., an uplink frame or a downlink frame). In case of a downlink frame of which a From DS bit of the FC field of the short MAC header is set to 1, the A2 field of the Nonce can be configured by an MAC address of the transmission STA (or an AP) or a BSSID (6 octets). For example, the A2 field of the Nonce can be configured by the MAC address of the transmission STA (or the AP) or the BSSID (6 octets) identified by the A2 field of the short MAC header. In case of an uplink frame of which the From DS bit of the FC field of the short MAC header is set to 0, the A2 field of the Nonce can be configured by an AID (2 octets) of the transmission STA.

Method of Transmitting a Fragment Frame with a Short Data Frame Format

As an additional example of the present invention, if a length of an MSDU and an MMPDU is longer than a prescribed threshold, it is able to transmit the MSDU and the MMPDU by fragmenting the MSDU and the MMPDU.

In this case, it is able to continuously transmit a plurality of fragment frames.

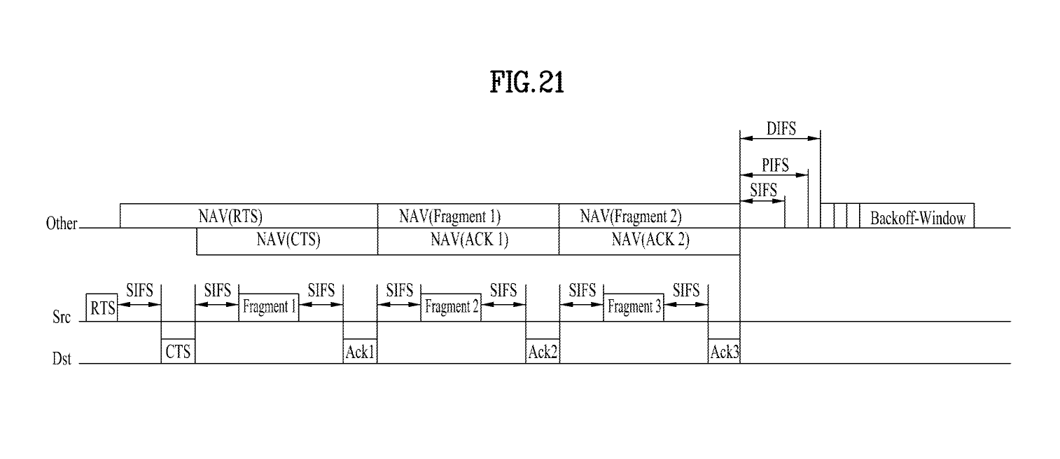

FIG. 21 is a diagram for a method of transmitting a fragment according to one example of the present invention.

For example, a source UE exchanges an RTS frame and a CTS frame with a destination UE before the source UE transmits a fragment frame to the destination UE, other UE (or a third party station) configures NAV and may be able to defer a channel access during the NAV.

If the source UE fragments a single MSDU into 3 fragmented frames, as shown in FIG. 21, the source UE transmits a fragment 1 and receives ACK1. Hence, the third party station configures the NAV based on the fragment 1/ACK1. After the ACK1 is received, the source UE transmits a fragment 2 with SIFS interval and receives ACK2. Hence, the third party station configures the NAV based on the fragment 2/ACK2. After the ACK2 is received, the source UE transmits a fragment 3 with SIFS interval and receives ACK3. Thereafter, the third party station can perform a backoff operation after DIFS elapses.

In order to enhance transmission efficiency of a fragment frame, in case of a Sub 1 GHz WLAN system, it may be able to use a short data frame format.

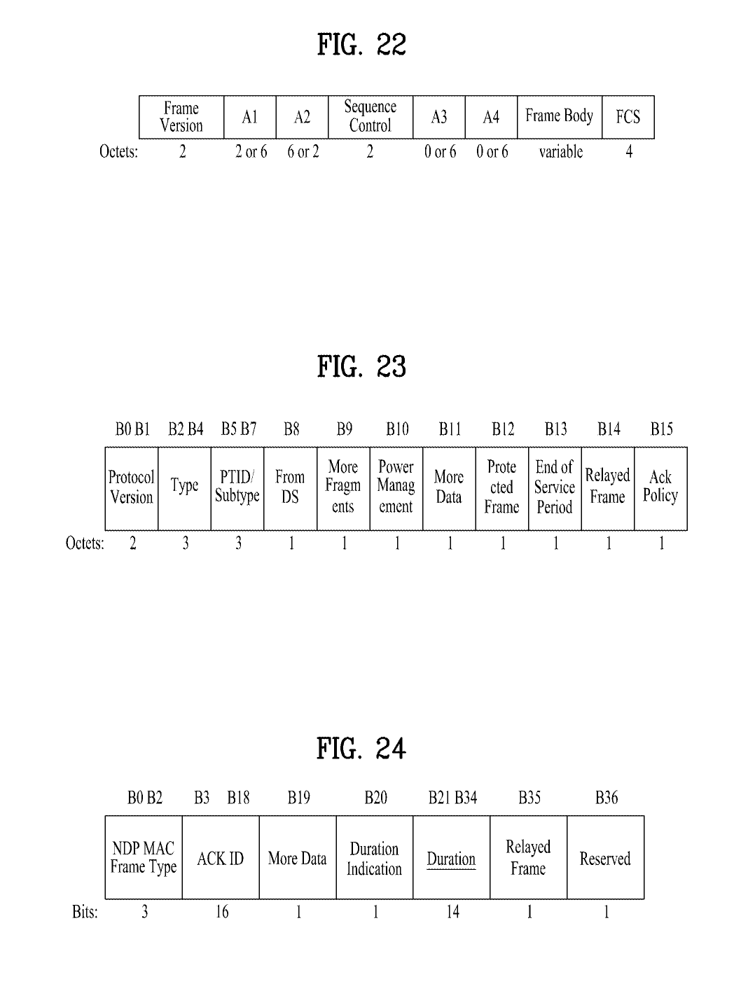

FIG. 22 is a diagram for an example of a short data frame format

As shown in FIG. 22, a short data frame format can be configured in a form of including an FC field (2 octets), an A1 field (2 or 6 octets), an A2 field (6 or 2 octets), an SC field (2 octets), an A3 field (this field may not be included. If included, 6 octets), an A4 field (this field may not be included. If included, 6 octets), a frame body and an FCS field (4 octets).

Specifically, in case of an uplink frame, a MAC address of a reception UE (i.e., AP) is included in the A1 field. In case of a downlink frame, an AID value of a reception UE (i.e., a non-AP STA) is included in the A2 field. The A3 field and the A4 field are selectively used. Unlike a general DATA frame, it is necessary to note that a Duration field is not included in a short DATA frame.

FIG. 23 is a diagram for an exemplary format of a FC field of a short data frame format.

If a fragment frame is transmitted with a short data frame format, a fragment procedure can be controlled by a More Fragment field. If there exist other fragment frames to be continuously transmitted after a fragment frame, a More Fragment field of the fragment frame is set to 1. If the fragment frame corresponds to a last fragment frame, the More Fragment field is set to 0.

In order to protect a control response frame such as ACK to be transmitted after a short DATA frame, a response indication field is included in a preamble header (e.g., SIG field).

The response indication field can be configured by a value indicating one selected from the group consisting of No Response, NDP Response, Normal Response and Long Response.

The No Response indicates that there is no frame to be transceived after a short DATA frame.

The NDP Response indicates that an NDP control frame such as NDP ACK or NDP Block ACK is transceived after a short DATA frame. In this case, the NDP control frame corresponds to a frame of which signaling information of a control frame is included in a preamble header (e.g., SIG field) instead of an MPDU.

The Normal Response indicates that a general control frame such as ACK or a Block ACK is transceived after a short DATA frame.

The Long Response indicates that a frame of a random size equal to or less than a size of maximum PPDU is transceived after a short DATA frame.

Hence, a third party station, which is hearing a short DATA frame, can determine a time length for deferring channel access of the third party station via a value of the Response Indication field. This can be called RID (Response Indication Deferral) virtual carrier sensing.

An example of transmitting a fragment frame using a short DATA frame format is explained in detail in the following description.

If a More Fragment value of an FC field corresponds to 1 in a fragment frame transmitted using a short DATA frame format (i.e., if it is not a last fragment frame), a Response indication value of a preamble header (e.g., SIG field) of the frame is set to Long Response. Since there are fragment frames to be continuously transmitted after the fragment frame, it is necessary to be understood as protecting following fragment frames. In particular, although it is necessary to receive a response for the fragment frame in a form of a normal ACK, in case of a fragment frame, the Response Indication field should be configured by a value indicating a maximum length (i.e., Long response) instead of an actual ACK type to protect following fragment frames.

If a More Fragment value of an FC field corresponds to 0 in a fragment frame transmitted using a short DATA frame format (i.e., if it is a last fragment frame), a Response Indication value of a preamble header (e.g., SIG field) of the frame is set to NDP Response or Normal Response). Since there is no fragment frame to be continuously transmitted after the fragment frame. It is necessary to be understood as protecting an ACK frame only following the last fragment frame. In this case, if the ACK, which is transceived after the last fragment frame, corresponds to an NDP control frame, the Response Indication field of the last fragment frame is configured by a value indicating NDP Response. If the ACK corresponds to a general control frame, the Response indication field of the last fragment frame is configured by a value indicating Normal Response.

When a UE receives a fragment frame using a short DATA frame format, if a More Fragment value of an FC field corresponds to 1 in the fragment frame if there exists a fragment frame to be received after the fragment frame), the UP configures a value of a Duration field of an ACK frame by a value corresponding to Max PPDU or a prescribed value indicating Long Response when the UE transmits the ACK frame in response to the fragment frame. Meanwhile, if the More Fragment value of the FC field corresponds to 0 in the fragment frame (i.e., if there is no fragment frame to be received after the fragment frame), the UE sets a value of a Duration field of an ACK frame to 0 when the UE transmits the ACK frame in response to the fragment frame. In this case, the ACK frame transmitted by the reception UE may correspond to a NDP ACK frame or a normal ACK frame.

FIG. 24 is a diagram for an exemplary format of an NDP ACK frame.

An NDP MAC frame type field is defined by a 3-bit size and can be configured by a value indicating that a corresponding frame corresponds to an NDP ACK frame.

An ACK ID field is defined by a 16-bit size and can be configured by a scrambler initialization value of a service field before scrambling is performed and a value of a bit sequence obtained from an FCS field of PSDU carrying a soliciting frame. The bit sequence is defined by Scrambler Initialization [0:6]∥FCS [23:31]. In this case, [a:b] indicates bits ranging from bit a to bit b when a position of a start bit of a binary number value corresponds to bit 0. The ∥ corresponds to concatenation calculation.

A More Data field is defined by a 1-bit size and indicates whether or not there exists a buffered data.

A Duration indication field is defined by a 1-bit size and a Duration field is defined by a 14-bit size. If a value of the Duration field configures NAV, a value of the Duration Indication field is set to 0. If a value of the Duration field indicates an idle section, a value of the Duration Indication field is set to 1.

A Relayed Frame field is defined by a 1-bit size and the remaining 1 bit is reserved.

As an additional example of transmitting a fragment frame using a short data format, a method of using Block ACK instead of ACK is explained in the following.

If a length of MSDU or MMPDU to be transmitted is greater than a prescribed threshold, a transmission UE can perform an operation of fragmenting the MSDU or the MMPDU. Each of fragment frames can be independently transmitted. For example, assume a ease that a single MSDU is fragmented into 5 fragment frames (e.g., fragment 1, fragment 2, fragment 3, fragment 4 and fragment 5). In this case, all of the fragment 1, the fragment 2, the fragment 3, the fragment 4 and the fragment 5 are transmitted with an SIFS interval and it is able to receive a block ACK frame from a reception UE. If an error occurs on a part of the fragment frames, it is able to retransmit a corresponding fragment frame on which the error has occurred. For example, if a reception error occurs on the fragment 2 and the fragment 4, the reception UE recognizes a tact of error occurrence via a bitmap of a block ACK transmitted by the transmission UE and performs retransmission for the fragment 2 and the fragment 4 only. In particular, it is not necessary to sequentially transmit all fragment frames all the time.

In order to independently transmit the fragment frames, each of the fragment frames indicates a following operation of a UE, which has received the corresponding fragment frame, via an ACK policy value of a MAC header. For example, if a transmitted fragment frame is not a last fragment frame, the fragment frame configures the ACK policy value of the MAC header as a block ACK value, informs a reception UE that a different fragment frame is to be transmitted in succession, and makes the reception UE ready for a block ACK bitmap. If a transmitted frame corresponds to a last fragment frame, an ACK policy value of a MAC header of the fragment frame is configured as an implicit block ACK request value and it is able to request to transmit a block ACK frame with an SIFS interval thereafter.

If a More Fragment value of an FC field corresponds to 1 in a fragment frame transmitted using a short DATA frame format (i.e., if it is not a last fragment frame) and a value of ACK Policy field is configured by a value indicating Block ACK, a Response Indication value of a preamble header (e.g., SIG field) of the frame is set to Long Response. Since there are fragment frames to be continuously transmitted after the fragment frame, it is necessary to be understood as protecting following fragment frames.

If a More Fragment value of an FC field corresponds to 0 in a fragment frame transmitted using a short DATA frame format (i.e., if it is a last fragment frame) or a value of ACK Policy field is configured by a value indicating Implicit Block ACK Request, a Response Indication value of a preamble header (e.g., SIG field) of the frame is set to NDP Response (or Normal Response). Since there is no fragment frame to be continuously transmitted after the fragment frame, it is necessary to be understood as protecting a Block ACK frame only following the last fragment frame. In this case, if the Block ACK, which is transceived after the last fragment frame, corresponds to an NDP control frame, the Response Indication field of the last fragment frame is configured by a value indicating NDP Response. If the Block ACK corresponds to a general control frame, the Response Indication field of the last fragment frame is configured by a value indicating Normal Response.

When a UE receives a fragment frame using a short DATA frame format, if a More Fragment value of an FC field corresponds to 0 in the fragment frame (i.e., if there is no fragment frame to be received after the fragment frame) or a value of ACK Policy field is configured by a value indicating implicit Block ACK Request, the DE sets a value of a Duration field of an ACK frame to 0 when the DE transmits the Block ACK frame. In this case, the ACK frame transmitted by the reception UE may correspond to a NDP Block ACK frame or a Block ACK frame.

FIG. 25 is a flowchart for explaining a method according to one example of the present invention.

FIG. 25(a) shows an example of transmitting a response frame to each of a plurality of fragment frames and FIG. 25(b) shows an example of transmitting a block ACK to a plurality of fragment frames.

In the examples of FIGS. 25(a) and (b), if a length of a single frame (e.g., Long frame) exceeds a prescribed threshold, it is able to generate a plurality of fragment frames (e.g., a plurality of short frames of a plurality of short data frames) from the single frame.

In a frame (e.g., a fragment frame of which a value of More Fragment field corresponds to 1), which is not a last frame among a plurality of the fragment frames, a response indication field can be configured by a value indicating a maximum length (e.g., Long Response). Meanwhile, in a last fragment frame (e.g., a fragment frame of which a value of More Fragment field corresponds to 0), among a plurality of the fragment frames, a response indication field is configured by a value indicating an NDP response or a normal response in FIG. 25(a) and the response indication field can be configured by to value indicating an NDP block ACK response or a block ACK response in FIG. 25(b).

Although an exemplary method described in FIG. 25 is represented by a series of operations for clarity, an order of performing steps may be non-limited by the method. If necessary, each of the steps can be performed at the same time or can be performed in a different order. And, it is not mandatory to have all steps shown in the example of FIG. 25 to implement the method proposed by the present invention.

In case of performing the exemplary method shown in FIG. 25, the aforementioned items mentioned earlier in various embodiments of the present invention can be independently applied. Or, the method can be implemented in a manner of applying two or more embodiments at the same time.

FIG. 2 is a block diagram for a configuration of a wireless device according to one embodiment of the present invention.

An STA1 10 can include a processor 11, a memory 12 and a transceiver 13. An STA2 can include a processor 21, a memory 22 and a transceiver 23. The transceiver 13/23 can transmit/receive a radio signal. For example, the transceiver can implement a physical layer according to IEEE 802 system. The processor 11/21 is connected with the transceiver 13/23 and can implement a physical layer and/or an MAC layer according to IEEE 802 system. The processor 11/21 can be configured to perform an operation according to various embodiments of the present invention. And, a module configured to implement operations of the STA1 and the STA2 according to the various embodiments of the present invention is stored in the memory 12/22 and the module can be executed by the processor 11/21. The memory 12/22 is included in the inside of the processor 11/21 or is installed in the outside of the processor 11/21 and can be connected with the processor 11/21 by a well-known means.

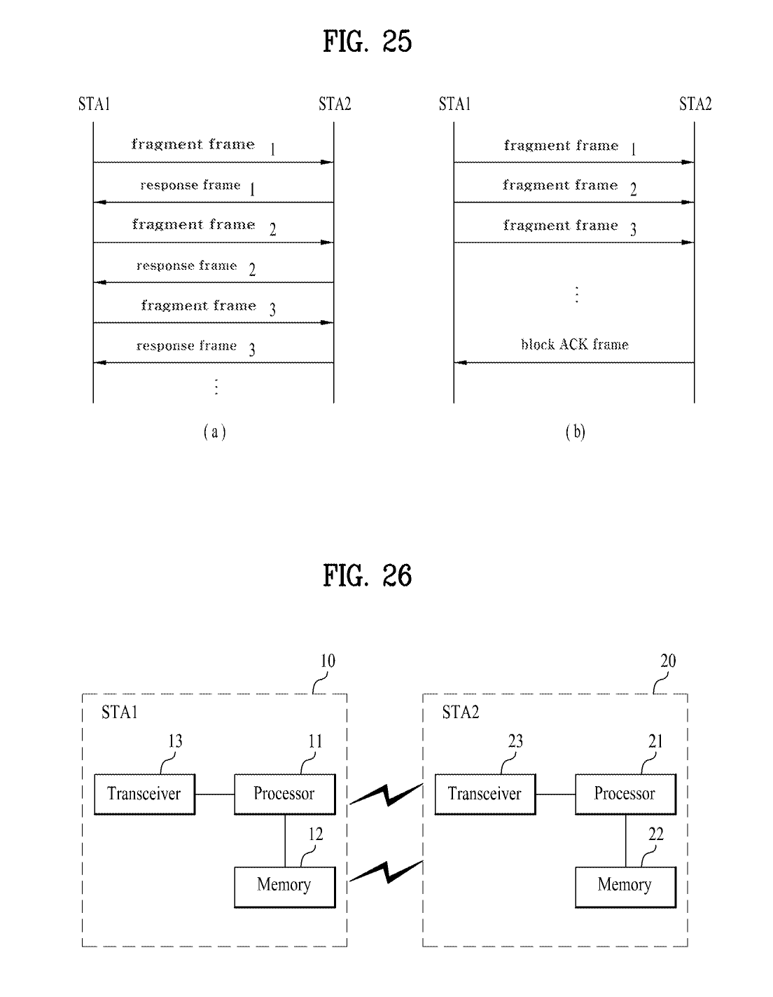

For a detailed configuration of the STA1 10 and the STA2 20 shown in FIG. 26, the items mentioned earlier in various embodiments of the present invention can be independently applied or two or more embodiments can be applied at the same time. For clarity, explanation on overlapped contents is omitted at this time.

The embodiments of the present invention may be implemented through various means. For example, the embodiments can be implemented by hardware, firmware, software, or a combination thereof.

When implemented as hardware, a method according to embodiments of the present invention may be embodied as one or more application specific integrated circuits (ASICs), one or more digital signal processors (DSPs), one or more digital signal processing devices (DSPDs), one or more programmable logic devices (PLDs), one or more field programmable gate arrays (FPGAs), a processor, a controller, a microcontroller, a microprocessor, etc.

When implemented as firmware or software, a method according to embodiments of the present invention may be embodied as a module, a procedure, or a function that performs the functions or operations described above. Software code may be stored in a memory unit and executed by a processor. The memory unit is located at the interior or exterior of the processor and may transmit and receive data to and from the processor via various known means.

Preferred embodiments of the present invention have been described in detail above to allow those skilled in the art to implement and practice the present invention. Although the preferred embodiments of the present invention have been described above, those skilled in the art will appreciate that various modifications and variations can be made in the present invention without departing from the spirit or scope of the invention. For example, those skilled in the art may use a combination of elements set forth in the above-described embodiments. Thus, the present invention is not intended to be limited to the embodiments described herein, but is intended to accord with the widest scope corresponding to the principles and novel features disclosed herein.

### INDUSTRIAL APPLICABILITY

Although various embodiments of the present invention are explained centering on IEEE 802.11 system, the embodiments can also be applied to various mobile communication systems with an identical scheme.

What is claimed is:

1. A method of transmitting a fragment frame by a station (STA) in a wireless LAN system, the method comprising:
transmitting a plurality of fragment frames generated from a single frame; and
receiving a response frame in response to one or more fragment frames among the plurality of the fragment frames,
wherein a response indication field of a fragment frame other than a last fragment frame among the plurality of the fragment frames, is configured by a value indicating a maximum length.

2. The method of claim 1, wherein the response indication field of the fragment frame other than the last fragment frames, is configured by a value indicating a long response.

3. The method of claim 1, wherein a response indication field of the last fragment frame is configured by a value indicating, an null data packet (NDP) response or as normal response.

4. The method of claim 1, wherein if as response frame is received in response to each of the plurality of the fragment frames, a duration field of the response frame for the fragment frame other than the last fragment frame, is configured by a value indicating a maximum length.

5. The method of claim 1, wherein if a response frame is received in response to each of the plurality of the fragment frames, a duration field of the last fragment frame is set to 0.

6. The method of claim 1, wherein when a response frame for the plurality of the fragment frames is received as a block ACK frame,
if a value of an ACK policy field of the it frame other than the last fragment frame, is continued by a value indicating a block ACK, the response indication field of the fragment frame other than the last fragment frame, is configured by a value indicating the maximum length.

7. The method of claim 1, wherein when a response frame for the plurality of the fragment frames is received as a block ACK frame,
if a value of an ACK policy field of a single fragment frame among the plurality of the fragment frames is configured by a value indicating an implicit block ACK request, a response indication field of the single fragment frame is configured by a value indicating an null data packet (NDP) block ACK response or a block ACK response.

8. The method of claim 1, wherein when a response frame for the plurality of the fragment frames is received as block ACK frame,
if a value of an ACK policy field of a single fragment frame among the plurality of the fragment frames is configured by a value indicating an implicit block ACK request, a value of a duration field of the block ACK frame is set to 0.

9. The method of claim 1, wherein a value of a More fragment field of an frame control (FC) field of the fragment frame other than the last fragment frame, is set to 1 and wherein a value of a More fragment field of an frame control (FC) field of the last fragment frame is set to 0.

10. The method of claim 1, wherein each of the plurality of the fragment frames is transmitted using a short data frame format.

11. The method of claim 1, wherein a More Fragment bit is masked to if in additional authentication data (ADD) for each of the plurality of the fragment frames,

12. The method of claim 1, wherein a More Fragment bit is masked to 0 in Nonce for each of the plurality of the fragment frames.

13. A method of receiving a fragment frame by a station (STA) in a wireless LAN system, the method comprising:
receiving a plurality of fragment frames generated from a single frame; and
transmitting a response frame in response to one or more fragment frames among the plurality of the fragment frames,
wherein a response indication field of a fragment frame other than a last fragment frame among the plurality of the fragment frames, is configured by a value indicating a maximum length.

14. A station (STA) transmitting a fragment frame in a wireless LAN system, comprising:
a transceiver; and
a processor,
wherein the processor is configured to control the transceiver to transmit a plurality of fragment frames generated from a single frame and to receive a response frame in response to one or more fragment frames among the plurality of the fragment frames,
wherein a response indication field of a fragment frame other than a last fragment frame among the plurality of the fragment frames, is configured by a value indicating a maximum length.

15. A station (STA) receiving a fragment frame in a wireless LAN system, comprising:
a transceiver; and
a processor,
wherein the processor is configured to control the transceiver to receive a plurality of fragment frames generated from a single frame and to transmit a response frame in response to one or more fragment frames among the plurality of the fragment frames,
wherein a response indication field of a fragment frame other than a last fragment frame among the plurality of the fragment frames, is configured by a value indicating a maximum length.
